(19) United States
(12) Patent Application Publication
(10) Pub. No.: US 2023/0142220 A1
(43) Pub. Date: May 11, 2023

(54) COMPOSITIONS AND METHODS FOR CONTROLLING FUNGAL DISEASES IN PLANTS

(71) Applicant: FMC Corporation, Philadelphia, PA (US)

(72) Inventors: Vanessa Cristina FRARE, Paulínia (BR); Eduardo DA CRUZ MADURO PICELLI, Paulínia (BR); Luis Alfredo Rauer DEMANT, Paulínia (BR)

(21) Appl. No.: 17/916,106

(22) PCT Filed: Mar. 31, 2021
(86) PCT No.: PCT/US2021/025242

§ 371 Date: Sep. 30, 2022

Related U.S. Application Data
(60) Provisional application No. 63/004,233, filed on Apr. 2, 2020.

(51) Int. Cl. A01N 63/22; A01N 43/56; A01P 3/00

(52) U.S. Cl. CPC A01N 63/22; A01N 43/56; A01P 3/00

(57) ABSTRACT

Methods for controlling phytopathogenic fungi with a combination of fungicides comprising Bacillus amyloliquefaciens, in particular Bacillus amyloliquefaciens FCC1256, and a succinate dehydrogenase inhibitor, in particular fluindapyr, are provided. Fungicidal compositions comprising a combination of Bacillus amyloliquefaciens and a succinate dehydrogenase inhibitor are further provided. The methods and compositions provide particular utility for the control of Phakopsora pachyrhizi and Phakopsora meibomiae and Puccinia triticina.

### REFERENCE TO EARLIER APPLICATIONS

This application claims priority to provisional application Ser. No. 63/004,233, filed Apr. 2, 2020, which is incorporated herein by reference in its entirety.

### FIELD OF THE DISCLOSURE

The field of the disclosure relates generally to pesticidal compositions comprising Bacillus amyloliquefaciens and a chemical fungicide, and methods of use thereof to control plant pathogens.

### BACKGROUND

Fungal plant pathogens (phytopathogens), including but not limited to Phakopsora spp., are one type of plant pest that can cause severe economic losses in the agricultural and horticultural industries. Chemical agents can be used to control fungal phytopathogens, but problematically the use of chemical agents suffers from disadvantages including high cost, lack of efficacy, emergence of resistant strains of the fungi, and undesirable environmental impact. In addition, such chemical treatments tend to be indiscriminant and may adversely affect beneficial bacteria, fungi, and arthropods in addition to the plant pathogen at which the treatments are targeted.

Microbial fungicides, such as certain strains of Bacillus amyloliquefaciens, can also be used to control fungal phytopathogens. Problematically, biopesticides under certain conditions may have disadvantages such as high specificity; slow speed of action; variable efficacy due to the influences of various biotic and abiotic factors; and resistance development.

Problematically, repeated and exclusive application of an individual active component in the control of phytopathogens may lead to selection of those fungus strains or pest isolates which have developed natural or adapted resistance against the active component in question. Effective control of such phytopathogens with the active component in question is then no longer possible.

WO 2015/177021 discloses pesticidal mixtures comprising one of certain Bacillus strains and a pesticide, as well as agricultural uses thereof.

EP2962568A1 discloses pesticidal mixtures comprising a Bacillus amyloliquefaciens ssp. plantarum strain TJ1000 and a pesticide, as well as agricultural uses thereof.

However, despite the availability of certain biological pesticides and chemical pesticides, there is a need in the art to improve specificity against the target diseases and their respective causal pathogens. Further, there is a need to improve efficacy and potency of biological pesticides which may be impacted by various biotic and abiotic factors. Yet further, there is a need to reduce pesticide dosage rates in order to minimize unfavorable environmental or toxicological effects while providing effective pest control.

### BRIEF DESCRIPTION

In some aspects, a method for controlling phytopathogenic fungi is provided, e.g. for controlling Phakopsora pachyrhizi, Phakopsora meibomiae and/or Puccinia sp., like Puccinia triticina The method comprises treating plants, plant propagation material, and/or associated soil with a pesticidal composition comprising an effective amount of: (1) a Bacillus amyloliquefaciens fungicide component comprising a population of Bacillus amyloliquefaciens FCC1256; and (2) a second fungicide component comprising at least one fungicide selected from fluindapyr and salts thereof.

In some aspects, a pesticidal composition is provided. The pesticidal composition comprises (1) a Bacillus amyloliquefaciens fungicide component comprising a population of Bacillus amyloliquefaciens FCC1256, and (2) a second fungicide component comprising at least one fungicide selected from fluindapyr and salts thereof. In the pesticidal composition, the population of Bacillus amyloliquefaciens FCC1256 and fluindapyr are typically present in a ratio of from about 1×10⁷ CFU Bacillus amyloliquefaciens FCC1256 per gram fluindapyr to about 1×10¹⁵ CFU Bacillus amyloliquefaciens FCC1256 per gram fluindapyr.

In some aspects, a method for controlling phytopathogenic fungi is provided. The method comprises treating plants, plant propagation material, and/or associated soil with a pesticidal composition comprising an effective amount of: (1) a Bacillus amyloliquefaciens fungicide component comprising a population of at least one strain of Bacillus amyloliquefaciens; and (2) a second fungicide component comprising at least one fungicide selected from the group consisting of succinate dehydrogenase inhibitors, such as fluindapyr. The Bacillus amyloliquefaciens fungicide component and the second fungicide component are present in a synergistically effective amount; the population of the Bacillus amyloliquefaciens contained in the Bacillus amyloliquefaciens fungicide component and the second fungicide component are present in a ratio of from about 1×10⁷ CFU Bacillus amyloliquefaciens per gram succinate dehydrogenase inhibitor active ingredient to about 1×10¹⁵ CFU Bacillus amyloliquefaciens per gram succinate dehydrogenase inhibitor active ingredient; and the phytopathogenic fungi is selected from the group consisting of Phakopsora pachyrhizi and Phakopsora meibomiae.

In some aspects, a pesticidal composition is provided. The composition comprises: (1) a Bacillus amyloliquefaciens fungicide component comprising a population of at least one strain of Bacillus amyloliquefaciens, and (2) a second fungicide component comprising at least one fungicide selected from the group consisting of succinate dehydrogenase inhibitors. The population of the Bacillus amyloliquefaciens contained in the Bacillus amyloliquefaciens fungicide component and the second fungicide component are present in a ratio of from about 1×10⁷ CFU Bacillus amyloliquefaciens per gram succinate dehydrogenase inhibitor active ingredient to about 1×10¹⁵ CFU Bacillus amyloliquefaciens per gram succinate dehydrogenase inhibitor active ingredient.

In some aspects, a method for controlling phytopathogenic fungus is provided. The method comprises treating plants, plant propagation material, and/or soil with an effective amount of a pesticidal composition comprising: (1) a Bacillus amyloliquefaciens fungicide component comprising a population of at least one strain of Bacillus amyloliquefaciens, and (2) a second fungicide component comprising at least one fungicide selected from the group consisting of succinate dehydrogenase inhibitors. The population of the Bacillus amyloliquefaciens contained in the Bacillus amyloliquefaciens fungicide component and the second fungicide component are present in a ratio of from about 1×10⁷ CFU Bacillus amyloliquefaciens per gram succinate dehydrogenase inhibitor active ingredient to about 1×10¹⁵ CFU Bacillus amyloliquefaciens per gram succinate dehydrogenase inhibitor active ingredient.

### DESCRIPTION OF THE DRAWINGS

FIG. 1 depicts the results for: an untreated soybean leaf control inoculated with P. pachyrhizi; a soybean leaf treated with a formulation comprising 2×10¹¹ CFU/ha B. amyloliquefaciens species FCC1256 (Formulation 2) followed one day later by inoculation with P. pachyrhizi; a soybean leaf treated with a formulation comprising 80 g a.i./ha fluindapyr and 1000 g a.i./ha chlorothalonil (Formulation 7) followed one day later by inoculation with P. pachyrhizi, and a soybean leaf treated with a formulation comprising 2×10¹¹ CFU/ha B. amyloliquefaciens, 80 g a.i./ha fluindapyr and 1000 g a.i./ha chlorothalonil (Formulation 10) followed one day later by inoculation with P. pachyrhizi. Each depicted leaf is shown 12 days after inoculation with P. pachyrhizi.

FIG. 2 depicts the results for: an untreated soybean leaf control inoculated with P. pachyrhizi; a soybean leaf treated with formulation comprising 2×10¹¹ CFU/ha B. amyloliquefaciens species FCC1256 (Formulation 2) followed one day later by inoculation with P. pachyrhizi; a soybean leaf treated with a formulation comprising 80 g a.i./ha fluindapyr (Formulation 17) followed one day later by inoculation with P. pachyrhizi; a soybean leaf treated with a formulation comprising 2×10¹¹ CFU/ha B. amyloliquefaciens and 80 g a.i./ha fluindapyr (Formulation 16) followed one day later by inoculation with P. pachyrhizi; and a soybean leaf treated with a mancozeb control followed one day later by inoculation with P. pachyrhizi. Each depicted leaf is shown 12 days after inoculation with P. pachyrhizi.

FIG. 3 depicts results for the combination of Bacillus amyloliquefaciens FCC1256 and fluindapyr as further described in Example 2.

FIGS. 4-7 depict results for the combination of Bacillus amyloliquefaciens FCC1256 and certain synthetic fungicides as further described in Example 3.

### DETAILED DESCRIPTION

The present disclosure is generally directed to compositions comprising: (1) a Bacillus amyloliquefaciens fungicide component comprising a population of at least one strain of Bacillus amyloliquefaciens, and (2) a second fungicide component comprising at least one fungicide selected from the group consisting of succinate dehydrogenase inhibitors. The compositions have particular utility for controlling phytopathogenic fungi.

It has been discovered that the compositions and methods of the present disclosure provide for improved control of phytopathogenic fungi on plants at reduced application rates while providing for improved fungal phytotoxicity. In some aspects, the ability to control of phytopathogenic fungi of the fungicide combination is synergistic as compared to the B. amyloliquefaciens fungicide and succinate dehydrogenase inhibitor applied individually.

In addition, the compositions according to the disclosure may also have further surprising advantageous properties. Examples of such advantageous properties that may be mentioned are more advantageous degradability, improved toxicological and/or ecotoxicological behavior and/or improved characteristics of the useful plants. Such improved characteristics include emergence, crop yields, plant health, more developed root system, tillering increase, increase in plant height, bigger leaf blade, less dead basal leaves, stronger tillers, greener leaf color, less fertilizers needed, less seeds needed, more productive tillers, earlier flowering, early grain maturity, less plant verse (lodging), increased shoot growth, improved plant vigor, and/or early germination.

### Definitions

As used herein, the term “Bacillus amyloliquefaciens” with reference to a strain thereof refers to an essentially biologically pure culture of a B. amyloliquefaciens strain. Non-limiting examples of B. amyloliquefaciens strains include FCC1256 (deposited as ATCC No. PTA-122162, disclosed in WO 2020/069297, in short referred to as “FCC1256”)), AP-136, AP-188, AP-218, AP-219, AP-295, QST713, FZB24, FZB42, F727, MB1600, D747, RTI301, RTI472, and TJ100 (also called strain 1 BE; known from EP2962568). FCC1256 is a particularly interesting strain. Particularly interesting B. amyloliquefaciens strains are those capable of producing the lipopeptides fengycin and iturin, especially fengycin, iturin as well as surfactin. In some embodiments, the B. amyloliquefaciens strain produces iturin and fengycin in the relative weight ratio of from 0.8:1.0 to 5.0:1.0, such as from 1.0:1.0 to 4.0:1.0, e.g. from 1.3:1.0 to 3.0:1.0. The experiments reported herein indicates that the FCC1256 strain exhibits a remarkable synergistic effect when applied in combination with a fungicide, like fluindapyr, also when compared with other Bacillus amyloliquefaciens strains. It is speculated that the particular ability of FCC1256 to express iturin and fengycin in the before-mentioned ratios (as reported in WO 2020/069297) may be accountable for such a remarkable synergistic effect. Hence, it may be further speculated if other Bacillus amyloliquefaciens strains sharing the same intrinsic feature may show a synergistic effect at the same level.

In the methods, compositions, etc. described herein, the strain may be present in one or a combination of forms: as isolated spores of the bacterial stain, as a fermentation broth comprising spores of the bacterial strain, as a processed fermentation product comprising spores of the bacterial strain, as isolated vegetative cells of the bacterial strain, as a fermentation broth comprising vegetative cells of the bacterial strain, and as a processed fermentation product comprising vegetative cells of the bacterial strain.

As used herein, the term “biologically pure culture” refers a laboratory or fermentation culture which contains a single strain (species) of organism, i.e., in the present disclosure, virtually exclusively a B. amyloliquefaciens. This means that any other microorganisms involved in the fermentation broth of the pure culture are considered as contaminations, which only exist in a negligible amount and does not cause measurable changes to the physical and chemical compositions of the broth.

As used herein, the term “processed fermentation product” refers to a downstream processed form thereof, including but not limited to a concentrate of the fermentation broth, solids of a filtered fermentation broth, a reconstituted fermentation broth concentrate, and a dried fermentation broth (e.g., freeze-dried or spray-dried).

As used herein, the term “plant propagation material” refers to all the generative parts of a plant, including but not limited to seeds, roots, fruits, tubers, bulbs, rhizomes, parts of plants, and germinated plants and young plants which are to be transplanted after germination or after emergence from the soil.

As used herein, the terms “plant pathogen” and “phytopathogenic” refer to organisms that cause infectious disease in plants, including fungi, bacteria, viruses, viroids, virus-like organisms, oomycetes, phytoplasmas, protozoa, nematodes and parasitic plants. In some aspects, plant pathogens are selected from fungi and bacteria. In one aspect, plant pathogens are selected from fungal plant pathogens.

As used herein, the term “plant health” refers to a condition of the plant and/or its products which is determined by several indicators alone or in combination with each other such as yield (e.g., increased biomass and/or increased content of valuable ingredients), plant vigor (e.g., improved plant growth and/or greener leaves (“greening effect”)), quality (e.g., improved content or composition of certain ingredients) and tolerance to abiotic and/or biotic stress. The above identified indicators for the health condition of a plant may be interdependent, or may result from each other.

As used herein, the term “agriculturally acceptable” refers to a formulation medium as such as (i.e., without any deliberate inclusion of further active ingredients) that does not have significant detrimental effects on the plant or plants to which the agricultural composition is intended to be applied. Accordingly, an agriculturally acceptable formulation medium may include any such formulation medium in which B. amyloliquefaciens can be placed in to facilitate transport of an effective amount to be applied to the plant part of interest, and which is otherwise suitable for agricultural use.

As used herein, the term “aqueous carrier” refers to a predominantly based on water and comprising up to 5% by weight of non-water constituent(s).

As used herein, the term “effective amount” refers to an amount of the composition which is sufficient to control at least one plant pathogen when applied to a plant, the seed from which the plant is grown, or the locus of the plant (e.g., growth medium) to protect the plant from injury by the pathogen.

As used herein, the terms “control” and “controlling” refer to killing a plant pathogen or inhibiting a plant pathogen (including mortality and/or reproduction disruption) of such pathogens that have infested a plurality of plants. “Control” and “controlling” may also refer to preventing an infestation of a pathogen in a plurality of plants. In the context of the methods and compositions of the present disclosure, control is intended to mean an at least 10% reduction of the growth of the plant pathogen(s) compared to corresponding conditions where the methods or the compositions are not utilized, e.g. in some embodiments an at least 30% reduction, or an at least 50% reduction, or an at least 70% reduction, or an at least 80% reduction, or an at least 90% reduction, or essentially an elimination of the growth. In the latter instance, the elimination of the growth may result in visual elimination of the plant pathogen(s). In some aspects of the disclosure, the control is synergistic.

As used herein, the term “applying to over-ground parts of a plant”, and the like, refers to application of the composition to the plant by aiming at the stem(s), the leave(s), the flower(s) and/or the fruit(s) of the plant. In other aspects, application is aimed at the locus at which the plant or plant parts grows or is to be planted, e.g., to root system of the plant or the soil around the roots system of the plant, or to the soil in which the plant (or plant parts) is to be planted; this collectively being referred to as “applying to the soil around the plant”.

As used herein, the terms “combinations thereof” and “mixtures thereof” as used herein refer to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, the term “emulsifiable concentrate” (EC) refers to a liquid, homogeneous formulation to be applied as an emulsion after dilution in water. EC formulations can further be diluted with water in a spray tank to form a spontaneous emulsion.

As used herein, the term “dispersible concentrate” (DC) refers to a liquid homogeneous formulation to be applied as a solid dispersion after dilution with water. DC formulations can be diluted with water in the spray tank to form a suspension concentrate (SC)

As used herein, the term “oil dispersible” (OD) formulation refers to a formulation comprising a solid active ingredient dispersed in oil.

As used herein, the term “suspoemulsion” (SE) refers to a formulation that combines two active ingredients with very different physical properties into one formulation.

As used herein, the term “tank mix” refers to a composition prepared by mixing at least one pesticidal ingredient in a commercially available form with an adjuvant and optionally a quantity of water in a tank by a user immediately before application.

As used herein, the term “premix” refers to a composition prepared by mixing at least one pesticidal ingredient in a commercially available form with an adjuvant and optionally a quantity of water. Pre-mix as disclosed herein is defined as a mixture two or more biologically active agents (pesticides). In one aspect, a pre-mix may be sold in one package. In one aspect, a pre-mix may further comprise one more adjuvants such as surfactants, emulsifying agents, petroleum-based crop oils, crop-derived seed oils, pH adjusters, thickeners, spreader stickers and/or defoaming agents, as described elsewhere herein.

As used herein, the terms “synergy”, “synergism” and “synergistic effect” refer to the action of an active ingredient combination is greater than the sum of the actions of the individual components. The action to be expected E for a given active ingredient combination obeys the so-called COLBY formula and can be calculated as follows (Colby, S. R. “Calculating synergistic and antagonistic responses of herbicide combination”, Weeds, Vol. 15, pages 20-22; 1967)

E=X+Y−(X)(Y)/100

where: X is the observed efficacy of a first active ingredient at a given application rate; Y is the observed efficacy of a second active ingredient at application rate; and E is the expected efficacy of the co-application of X and Y at the application rates of each. A synergistic effect is indicated if the observed efficacy (O) of a co-application of X and Y at the same application rates is greater than E. An additive effect is indicated if O and E are equal. An antagonistic effect is indicated if O is less than E.

As used herein, the terms “a,” “an,” and “the” refer to “one or more” when used in this application, including the claims. Thus, for example, reference to “a plant” includes a plurality of plants, unless the context clearly is to the contrary.

As used herein, the terms “comprise,” “comprises,” and “comprising” are used in a non-exclusive sense, except where the context requires otherwise.

As used herein, the term “include” and its grammatical variants are intended to be non-limiting, such that recitation of items in a list is not to the exclusion of other like items that can be substituted or added to the listed items.

As used herein, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Phytopathogenic Fungi

Phytopathogenic fungi within the scope of the present disclosure include Phakopsoraceae and Puccinia. Non-limiting examples of Phakopsoraceae include P. pachyrhizi and P. meibomiae. A non-limiting example of a phytopathogenic fungal disease associated with Phakopsoraceae sp. is Asian soybean rust (ASR). Non-limiting examples of Puccinia include P. triticina. A non-limiting example of a phytopathogenic fungal disease associated with Puccinia sp. is wheat leaf rust.

In view of the promising results reported herein for the combination of Bacillus amyloliquefaciens FCC1256 and fluindapyr in the control of Phakopsoraceae sp. and Puccinia sp., it is speculated that this combination may also be applicable for the control of other phytopathogenic fungi, for example one or more selected from Basidiomycetes, Ascomycetes, Deuteromycetes or imperfect fungi, Oomycetes: Ustilago spp., Tilletia spp., Uromyces spp., Rhizoctonia spp., Erysiphe spp., Sphaerotheca spp., Podosphaera spp., Uncinula spp., Helminthosporium spp., Rhynchosporium spp., Pyrenophora spp., Monilinia spp., Sclerotinia spp., Septoria spp. (Mycosphaerella spp.), Venturia spp., Botrytis spp., Alternaria spp., Fusarium spp., Cercospora spp., Cercosporella herpotrichoides, Colletotrichum spp., Pyricularia oryzae, Sclerotium spp., Phytophtora spp., Pythium spp., Plasmopara viticola, Peronospora spp., Pseudoperonospora cubensis, and Bremia lactucae.

Compositions

Fungicides

In some aspects, the present disclosure is directed to the combination of (1) a B. amyloliquefaciens fungicide component comprising a population of at least one strain of B. amyloliquefaciens and (2) a second fungicide component comprising at least one fungicide selected from the group consisting of succinate dehydrogenase inhibitors (b7).

As used herein, “succinate dehydrogenase inhibitor (SDHI) fungicides (b7)” (FRAC code 7) refers to fungicides having a mode of action that inhibits complex II fungal respiration by disrupting a key enzyme in the Krebs Cycle (TCA cycle) named succinate dehydrogenase. SDHI salts are within the scope of the present disclosure. Inhibiting respiration prevents the fungus from making ATP, and thus inhibits growth and reproduction. SDHI fungicides include phenylbenzamide, phenyloxoethylthiophene amide, pyridinylethylbenzamide, furan carboxamide, oxathiin carboxamide, thiazole carboxamide, pyrazole-4-carboxamide, N-cyclopropyl-N-benzyl-pyrazole carboxamide, N-methoxy-(phenyl-ethyl)-pyrazole carboxamide, pyridine carboxamide and pyrazine carboxamide fungicides. The phenylbenzamides include benodanil, flutolanil and mepronil. The phenyloxoethylthiophene amides include isofetamid. The pyridinylethylbenzamides include fluopyram. The furan carboxamides include fenfuram. The oxathiin carboxamides include carboxin and oxycarboxin. The thiazole carboxamides include thifluzamide. The pyrazole-4-carboxamides include benzovindiflupyr, bixafen, flubeneteram (provisional common name, Registry Number 1676101-39-5), fluindapyr, fluxapyroxad, furametpyr, inpyrfluxam, isopyrazam, penflufen, penthiopyrad, pyrapropoyne (provisional common name, Registry Number 1803108-03-3), sedaxane and N-[2-(2,4-dichlorophenyl)-2-methoxy-1-methylethyl]-3-(difluoromethyl)-1-methyl-1H-pyrazole-4-carboxamide. The N-cyclopropyl-N-benzyl-pyrazole carboxamides include isoflucypram. The N-methoxy-(phenyl-ethyl)-pyrazole carboxamides include pydiflumetofen. The pyridine carboxamides include boscalid. The pyrazine carboxamides include pyraziflumid. In some aspects, the SDHI fungicide is a pyrazole-4-carboxamide. In some aspects, the SDHI fungicide is selected from benzovindiflupyr, bixafen, fluindapyr, fluxapyroxad, inpyrfluxam, and combinations thereof. In some preferred aspects, the SDHI fungicide is fluindapyr.

In addition to the primary combination of fungicides, i.e. the Bacillus amyloliquefaciens fungicide component (in particular Bacillus amyloliquefaciens FCC1256) and a second fungicide component, i.e. at least one fungicide selected from the group consisting of succinate dehydrogenase inhibitors (b7), in particular including fluindapyr (e.g. as the only succinate dehydrogenate inhibitor or in combination with other), the fungicide component of the present disclosure may optionally comprise at least one additional fungicide selected from the following: (b1) methyl benzimidazole carbamate (MBC) fungicides; (b2) dicarboximide fungicides; (b3) demethylation inhibitor (DMI) fungicides; (b4) phenylamide (PA) fungicides; (b5) amine/morpholine fungicides; (b6) phospholipid biosynthesis inhibitor fungicides; (b8) hydroxy(2-amino-)pyrimidine fungicides; (b9) anilinopyrimidine (AP) fungicides; (b10)N-phenyl carbamate fungicides; (b11) quinone outside inhibitor (QoI) fungicides; (b12) phenylpyrrole (PP) fungicides; (b13) azanaphthalene fungicides; (b14) cell peroxidation inhibitor fungicides; (b15) melanin biosynthesis inhibitor-reductase (MBI-R) fungicides; (b16a) melanin biosynthesis inhibitor-dehydratase (MBI-D) fungicides; (b16b) melanin biosynthesis inhibitor-polyketide synthase (MBI-P) fungicides; (b17) keto reductase inhibitor (KRI) fungicides; (b18) squalene-epoxidase inhibitor fungicides; (b19) polyoxin fungicides; (b20) phenylurea fungicides; (b21) quinone inside inhibitor (QiI) fungicides; (b22) benzamide and thiazole carboxamide fungicides; (b23) enopyranuronic acid antibiotic fungicides; (b24) hexopyranosyl antibiotic fungicides; (b25) glucopyranosyl antibiotic: protein synthesis fungicides; (b26) glucopyranosyl antibiotic fungicides; (b27) cyanoacetamideoxime fungicides; (b28) carbamate fungicides; (b29) oxidative phosphorylation uncoupling fungicides; (b30) organo tin fungicides; (b31) carboxylic acid fungicides; (b32) heteroaromatic fungicides; (b33) phosphonate fungicides; (b34) phthalamic acid fungicides; (b35) benzotriazine fungicides; (b36) benzene-sulfonamide fungicides; (b37) pyridazinone fungicides; (b38) thiophene-carboxamide fungicides; (b39) complex I NADH oxido-reductase inhibitor fungicides; (b40) carboxylic acid amide (CAA) fungicides; (b41) tetracycline antibiotic fungicides; (b42) thiocarbamate fungicides; (b43) benzamide fungicides; (b44) microbial fungicides; (b45) quinone outside inhibitor, stigmatellin binding (QoSI) fungicides; (b46) plant extract fungicides; (b47) cyanoacrylate fungicides; (b48) polyene fungicides; (b49) oxysterol binding protein inhibitor (OSBPI) fungicides; (b50) aryl-phenyl-ketone fungicides; (b51) host plant defense induction fungicides; (b52) multi-site activity fungicides; (b53) biologicals with multiple modes of action; (b54) fungicides other than fungicides of component (a) and components (b1) through (b53); and salts of compounds of (b1) through (b54).

As used herein, “methyl benzimidazole carbamate (MBC) fungicides (b1)” (FRAC code 1) refers to fungicides having a mode of action that inhibits mitosis by binding to β-tubulin during microtubule assembly. Inhibition of microtubule assembly can disrupt cell division, transport within the cell and cell structure. Methyl benzimidazole carbamate fungicides include benzimidazole and thiophanate fungicides. The benzimidazoles include benomyl, carbendazim, fuberidazole and thiabendazole. The thiophanates include thiophanate and thiophanate-methyl.

As used herein, “dicarboximide fungicides (b2)” (FRAC code 2) refers to fungicides having a mode of action that inhibits a mitogen-activated protein (MAP)/histidine kinase in osmotic signal transduction. Examples include chlozolinate, dimethachlone, iprodione, procymidone and vinclozolin.

As used herein, “demethylation inhibitor (DMI) fungicides (b3)” (FRAC code 3) (Sterol Biosynthesis Inhibitors (SBI): Class I) refers to fungicides having a mode of action that inhibits C14-demethylase, which plays a role in sterol production. Sterols, such as ergosterol, are needed for membrane structure and function, making them essential for the development of functional cell walls. Therefore, exposure to these fungicides results in abnormal growth and eventually death of sensitive fungi. DMI fungicides are divided between several chemical classes: piperazines, pyridines, pyrimidines, imidazoles, triazoles and triazolinthiones. The piperazines include triforine. The pyridines include buthiobate, pyrifenox, pyrisoxazole and (αS)-[3-(4-chloro-2-fluorophenyl)-5-(2,4-difluorophenyl)-4-isoxazolyl]-3-pyridinemethanol. The pyrimidines include fenarimol, nuarimol and triarimol. The imidazoles include econazole, imazalil, oxpoconazole, pefurazoate, prochloraz and triflumizole. The triazoles include azaconazole, bitertanol, bromuconazole, cyproconazole, difenoconazole, diniconazole (including diniconazole-M), epoxiconazole, etaconazole, fenbuconazole, fluquinconazole, flusilazole, flutriafol, hexaconazole, imibenconazole, ipconazole, ipfentrifluconazole, mefentrifluconazole, metconazole, myclobutanil, penconazole, propiconazole, quinconazole, simeconazole, tebuconazole, tetraconazole, triadimefon, triadimenol, triticonazole, uniconazole, uniconazole-P, α-(1-chlorocyclopropyl)-α-[2-(2,2-dichlorocyclopropyl)ethyl]-1H-1,2,4-triazole-1-ethanol, rel-1-[[(2R,3S)-3-(2-chlorophenyl)-2-(2,4-difluorophenyl)-2-oxiranyl]methyl]-1H-1,2,4-triazole, rel-2-[[(2R,3S)-3-(2-chlorophenyl)-2-(2,4-difluorophenyl)-2-oxiranyl]methyl]-1,2-dihydro-3H-1,2,4-triazole-3-thione and rel-1-[[(2R,3S)-3-(2-chlorophenyl)-2-(2,4-difluorophenyl)-2-oxiranyl]methyl]-5-(2-propen-1-ylthio)-1H-1,2,4-triazole. The triazolinthiones include prothioconazole. Biochemical investigations have shown that all of the above mentioned fungicides are DMI fungicides as described by K. H. Kuck et al. in Modern Selective Fungicides—Properties, Applications and Mechanisms of Action, H. Lyr (Ed.), Gustav Fischer Verlag: New York, 1995, 205-258.

As used herein, “phenylamide (PA) fungicides (b4)” (FRAC code 4) refers to fungicides having a mode of action that inhibits specific inhibitors of RNA polymerase in Oomycete fungi. Sensitive fungi exposed to these fungicides show a reduced capacity to incorporate uridine into rRNA. Growth and development in sensitive fungi is prevented by exposure to this class of fungicide. Phenylamide fungicides include acylalanine, oxazolidinone and butyrolactone fungicides. The acylalanines include benalaxyl, benalaxyl-M (also known as kiralaxyl), furalaxyl, metalaxyl and metalaxyl-M (also known as mefenoxam) The oxazolidinones include oxadixyl. The butyrolactones include ofurace

As used herein, “amine/morpholine fungicides (b5)” (FRAC code 5) (SBI: Class II) refers to fungicides having a mode of action that inhibits two target sites within the sterol biosynthetic pathway, Δ⁸→Δ⁷ isomerase and Δ¹⁴ reductase. Sterols, such as ergosterol, are needed for membrane structure and function, making them essential for the development of functional cell walls. Therefore, exposure to these fungicides results in abnormal growth and eventually death of sensitive fungi Amine/morpholine fungicides (also known as non-DMI sterol biosynthesis inhibitors) include morpholine, piperidine and spiroketal-amine fungicides. The morpholines include aldimorph, dodemorph, fenpropimorph, tridemorph and trimorphamide. The piperidines include fenpropidin and piperalin. The spiroketal-amines include spiroxamine.

As used herein, “phospholipid biosynthesis inhibitor fungicides (b6)” (FRAC code 6) refers to fungicides having a mode of action that inhibits growth of fungi by affecting phospholipid biosynthesis. Phospholipid biosynthesis fungicides include phophorothiolate and dithiolane fungicides. The phosphorothiolates include edifenphos, iprobenfos and pyrazophos. The dithiolanes include isoprothiolane.

As used herein, “hydroxy-(2-amino-)pyrimidine fungicides (b8)” (FRAC code 8) refers to fungicides having a mode of action that inhibits nucleic acid synthesis by interfering with adenosine deaminase. Examples include bupirimate, dimethirimol and ethirimol.

As used herein, “anilinopyrimidine (AP) fungicides (b9)” (FRAC code 9) are proposed to have a mode of action that inhibits biosynthesis of the amino acid methionine and to disrupt the secretion of hydrolytic enzymes that lyse plant cells during infection. Examples include cyprodinil, mepanipyrim and pyrimethanil.

As used herein, “N-Phenyl carbamate fungicides (b10)” (FRAC code 10) refers to fungicides having a mode of action that inhibits mitosis by binding to β-tubulin and disrupting microtubule assembly. Inhibition of microtubule assembly can disrupt cell division, transport within the cell and cell structure. Examples include diethofencarb.

As used herein, “quinone outside inhibitor (QoI) fungicides (b11)” (FRAC code 11) refers to fungicides having a mode of action that inhibits complex III mitochondrial respiration in fungi by affecting ubiquinol oxidase. Oxidation of ubiquinol is blocked at the “quinone outside” (Qo) site of the cytochrome bc₁ complex, which is located in the inner mitochondrial membrane of fungi. Inhibiting mitochondrial respiration prevents normal fungal growth and development. Quinone outside inhibitor fungicides include methoxyacrylate, methoxyacetamide, methoxycarbamate, oximinoacetate, oximinoacetamide and dihydrodioxazine fungicides (collectively also known as strobilurin fungicides), and oxazolidinedione, imidazolinone and benzylcarbamate fungicides. The methoxyacrylates include azoxystrobin, coumoxystrobin, enoxastrobin (also known as enestroburin), flufenoxystrobin, picoxystrobin and pyraoxystrobin. The methoxyacetamides include mandestrobin. The methoxycarbamates include pyraclostrobin, pyrametostrobin and triclopyricarb. The oximinoacetates include kresoxim-methyl and trifloxystrobin. The oximinoacetamides include dimoxystrobin, fenaminstrobin, metominostrobin and orysastrobin. The dihydrodioxazines include fluoxastrobin. The oxazolidinediones include famoxadone. The imidazolinones include fenamidone. The benzylcarbamates include pyribencarb.

As used herein, “phenylpyrrole (PP) fungicides (b12)” (FRAC code 12) refers to fungicides having a mode of action that inhibits a MAP/histidine kinase associated with osmotic signal transduction in fungi. Fenpiclonil and fludioxonil are examples of this fungicide class.

As used herein, “azanaphthalene fungicides (b13)” (FRAC code 13) are proposed to have a mode of action that inhibits signal transduction by a mechanism which is as yet unknown. They have been shown to interfere with germination and/or appressorium formation in fungi that cause powdery mildew diseases. Azanaphthalene fungicides include aryloxyquinolines and quinazolinones. The aryloxyquinolines include quinoxyfen. The quinazolinones include proquinazid.

As used herein, “cell peroxidation inhibitor fungicides (b14)” (FRAC code 14) are proposed to have a mode of action that inhibits lipid peroxidation which affects membrane synthesis in fungi. Members of this class, such as etridiazole, may also affect other biological processes such as respiration and melanin biosynthesis. Cell peroxidation fungicides include aromatic hydrocarbon and 1,2,4-thiadiazole fungicides. The aromatic hydrocarboncarbon fungicides include biphenyl, chloroneb, dicloran, quintozene, tecnazene and tolclofos-methyl. The 1,2,4-thiadiazoles include etridiazole.

As used herein, “melanin biosynthesis inhibitor-reductase (MBI-R) fungicides (b15)” (FRAC code 16.1) refers to fungicides having a mode of action that inhibits the naphthal reduction step in melanin biosynthesis. Melanin is required for host plant infection by some fungi. Melanin biosynthesis inhibitor-reductase fungicides include isobenzofuranone, pyrroloquinolinone and triazolobenzothiazole fungicides. The isobenzofuranones include fthalide. The pyrroloquinolinones include pyroquilon. The triazolobenzothiazoles include tricyclazole.

As used herein, “melanin biosynthesis inhibitor-dehydratase (MBI-D) fungicides (b16a)” (FRAC code 16.2) refers to fungicides having a mode of action that inhibits scytalone dehydratase in melanin biosynthesis. Melanin is required for host plant infection by some fungi. Melanin biosynthesis inhibitor-dehydratase fungicides include cyclopropanecarboxamide, carboxamide and propionamide fungicides. The cyclopropanecarboxamides include carpropamid. The carboxamides include diclocymet. The propionamides include fenoxanil.

As used herein, “melanin biosynthesis inhibitor-polyketide synthase (MBI-P) fungicides (b16b)” (FRAC code 16.3) refers to fungicides having a mode of action that inhibits polyketide synthase in melanin biosynthesis. Melanin is required for host plant infection by some fungi. Melanin biosynthesis inhibitor-polyketide synthase fungicides include trifluoroethylcarbamate fungicides. The trifluoroethylcarbamates include tolprocarb.

As used herein, “keto reductase inhibitor (KRI) fungicides (b17)” (FRAC code 17) refers to fungicides having a mode of action that inhibits 3-keto reductase during C4-demethylation in sterol production. Keto reductase inhibitor fungicides (also known as Sterol Biosynthesis Inhibitors (SBI): Class III) include hydroxyanilides and amino-pyrazolinones. Hydroxyanilides include fenhexamid Amino-pyrazolinones include fenpyrazamine Quinofumelin (provisional common name, Registry Number 861647-84-9) and ipflufenoquin (provisional common name, Registry Number 1314008-27-9) are also believed to be keto reductase inhibitor fungicides.

As used herein, “squalene-epoxidase inhibitor fungicides (b18)” (FRAC code 18) (SBI: Class IV) refers to fungicides having a mode of action that inhibits squalene-epoxidase in the sterol biosynthesis pathway. Sterols such as ergosterol are needed for membrane structure and function, making them essential for the development of functional cell walls. Therefore exposure to these fungicides results in abnormal growth and eventually death of sensitive fungi. Squalene-epoxidase inhibitor fungicides include thiocarbamate and allylamine fungicides. The thiocarbamates include pyributicarb. The allylamines include naftifine and terbinafine.

As used herein, “Polyoxin fungicides (b19)” (FRAC code 19) refers to fungicides having a mode of action that inhibits chitin synthase. Examples include polyoxin.

As used herein, “phenylurea fungicides (b20)” (FRAC code 20) are proposed to have a mode of action that affects cell division. Examples include pencycuron.

As used herein, “quinone inside inhibitor (QiI) fungicides (b21)” (FRAC code 21) refers to fungicides having a mode of action that inhibits complex III mitochondrial respiration in fungi by affecting ubiquinone reductase. Reduction of ubiquinone is blocked at the “quinone inside” (Qi) site of the cytochrome bc₁ complex, which is located in the inner mitochondrial membrane of fungi. Inhibiting mitochondrial respiration prevents normal fungal growth and development. Quinone inside inhibitor fungicides include cyanoimidazole, sulfamoyltriazole and picolinamide fungicides. The cyanoimidazoles include cyazofamid. The sulfamoyltriazoles include amisulbrom. The picolinamides include fenpicoxamid (Registry Number 517875-34-2).

As used herein, “benzamide and thiazole carboxamide fungicides (b22)” (FRAC code 22) refers to fungicides having a mode of action that inhibits mitosis by binding to β-tubulin and disrupting microtubule assembly. Inhibition of microtubule assembly can disrupt cell division, transport within the cell and cell structure. The benzamides include toluamides such as zoxamide. The thiazole carboxamides include ethylaminothiazole carboxamides such as ethaboxam.

As used herein, “enopyranuronic acid antibiotic fungicides (b23)” (FRAC code 23) refers to fungicides having a mode of action that inhibits growth of fungi by affecting protein biosynthesis. Examples include blasticidin-S.

As used herein, “hexopyranosyl antibiotic fungicides (b24)” (FRAC code 24) refers to fungicides having a mode of action that inhibits growth of fungi by affecting protein biosynthesis. Examples include kasugamycin.

As used herein, “glucopyranosyl antibiotic: protein synthesis fungicides (b25)” (FRAC code 25) refers to fungicides having a mode of action that inhibits growth of fungi by affecting protein biosynthesis. Examples include streptomycin.

As used herein, “glucopyranosyl antibiotic fungicides (b26)” (FRAC code U18, previously FRAC code 26 reclassified to U18) are proposed to have a mode of action that inhibits trehalase and inositol biosynthesis. Examples include validamycin.

As used herein, “cyanoacetamideoxime fungicides (b27)” (FRAC code 27) include cymoxanil.

As used herein, “carbamate fungicides (b28)” (FRAC code 28) are considered multi-site inhibitors of fungal growth. They are proposed to have a mode of action that interferes with the synthesis of fatty acids in cell membranes, which then disrupts cell membrane permeability. Iodocarb, propamacarb and prothiocarb are examples of this fungicide class.

As used herein, “oxidative phosphorylation uncoupling fungicides (b29)” (FRAC code 29) refers to fungicides having a mode of action that inhibits fungal respiration by uncoupling oxidative phosphorylation. Inhibiting respiration prevents normal fungal growth and development. This class includes dinitrophenyl crotonates such as binapacryl, meptyldinocap and dinocap, and 2,6-dinitroanilines such as fluazinam.

As used herein, “organo tin fungicides (b30)” (FRAC code 30) refers to fungicides having a mode of action that inhibits adenosine triphosphate (ATP) synthase in oxidative phosphorylation pathway. Examples include fentin acetate, fentin chloride and fentin hydroxide.

As used herein, “carboxylic acid fungicides (b31)” (FRAC code 31) refers to fungicides having a mode of action that inhibits growth of fungi by affecting deoxyribonucleic acid (DNA) topoisomerase type II (gyrase). Examples include oxolinic acid.

As used herein, “heteroaromatic fungicides (b32)” (FRAC code 32) are proposed to have a mode of action that affects DNA/ribonucleic acid (RNA) synthesis. Heteroaromatic fungicides include isoxazoles and isothiazolones. The isoxazoles include hymexazole and the isothiazolones include octhilinone.

As used herein, “phosphonate fungicides (b33)” (FRAC code P07, previously FRAC code 33 reclassified to P07) include phosphorous acid and its various salts, including fosetyl-aluminum.

As used herein, “phthalamic acid fungicides (b34)” (FRAC code 34) include teclofthalam.

As used herein, “benzotriazine fungicides (b35)” (FRAC code 35) include triazoxide.

As used herein, “benzene-sulfonamide fungicides (b36)” (FRAC code 36) include flusulfamide.

As used herein, “pyridazinone fungicides (b37)” (FRAC code 37) include diclomezine.

As used herein, “thiophene-carboxamide fungicides (b38)” (FRAC code 38) are proposed to have a mode of action that affects ATP production. Examples include silthiofam.

As used herein, “complex I NADH oxidoreductase inhibitor fungicides (b39)” (FRAC code 39) refers to fungicides having a mode of action that inhibits electron transport in mitochondria and include pyrimidinamines such as diflumetorim, pyrazole-5-carboxamides such as tolfenpyrad, and quinazoline such as fenazaquin.

As used herein, “carboxylic acid amide (CAA) fungicides (b40)” (FRAC code 40) refers to fungicides having a mode of action that inhibits cellulose synthase, which prevents growth and leads to death of the target fungus. Carboxylic acid amide fungicides include cinnamic acid amide, valinamide carbamate and mandelic acid amide fungicides. The cinnamic acid amides include dimethomorph, flumorph and pyrimorph. The valinamide carbamates include benthiavalicarb, benthiavalicarb-isopropyl, iprovalicarb, tolprocarb and valifenalate (also known as valiphenal). The mandelic acid amides include mandipropamid, N-[2-[4-[[3-(4-chlorophenyl)-2-propyn-1-yl]oxy]-3-methoxyphenyl]ethyl]-3-methyl-2-[(methylsulfonyl)amino]butanamide and N-[2-[4-[[3-(4-chlorophenyl)-2-propyn-1-yl]oxy]-3-methoxyphenyl]ethyl]-3-methyl-2-[(ethylsulfonyl)amino]butanamide.

As used herein, “tetracycline antibiotic fungicides (b41)” (FRAC code 41) refers to fungicides having a mode of action that inhibits growth of fungi by affecting protein synthesis. Examples include oxytetracycline.

As used herein, “thiocarbamate fungicides (b42)” (FRAC code M12, previously FRAC code 42 reclassified to M12) include methasulfocarb.

As used herein, “benzamide fungicides (b43)” (FRAC code 43) refers to fungicides having a mode of action that inhibits growth of fungi by delocalization of spectrin-like proteins. Examples include pyridinylmethyl benzamides such as fluopicolide and fluopimomide.

As used herein, “microbial fungicide (b44)”, (FRAC code BM02, previously FRAC code 44 reclassified to BM02) have a mode of action that disrupts fungal pathogen cell membranes. Microbial fungicides include Bacillus species and Trichoderma species.

As used herein, “quinone outside inhibitor, stigmatellin binding (QoSI) fungicides (b45)” (FRAC code 45) refers to fungicides having a mode of action that inhibits complex III mitochondrial respiration in fungi by affecting ubiquinone reductase at the “quinone outside” (Qo) site, stigmatellin binding sub-site, of the cytochrome bc₁ complex. Inhibiting mitochondrial respiration prevents normal fungal growth and development. QoSI fungicides include triazolopyrimidylamines such as ametoctradin.

As used herein, “plant extract fungicides (b46)” (FRAC code 46) refers to fungicides having a mode of action that causes cell membrane disruption. Plant extract fungicides include terpene hydrocarbons, terpene alcohols and terpen phenols such as the extract from Melaleuca alternifolia (tea tree) and plant oils (mixtures) such as eugenol, geraniol and thymol.

As used herein, “cyanoacrylate fungicides (b47)” (FRAC code 47) refers to fungicides having a mode of action that bind to the myosin motor domain and effect motor activity and actin assembly. Cyanoacrylates include fungicides such as phenamacril.

As used herein, “polyene fungicides (b48)” (FRAC code 48) refers to fungicides having a mode of action that causes disruption of the fungal cell membrane by binding to ergosterol, the main sterol in the membrane. Examples include natamycin (pimaricin).

As used herein, “oxysterol binding protein inhibitor (OSBPI) Fungicides (b49)” (FRAC code 49) refers to fungicides having a mode of action that bind to the oxysterol-binding protein in oomycetes causing inhibition of zoospore release, zoospore motility and sporangia germination. Oxysterol binding fungicides include piperdinylthiazoleisoxazolines such as oxathiapiprolin and fluoxapiprolin.

As used herein, “aryl-phenyl-ketone fungicides (b50)” (FRAC code 50, previously FRAC code U8 reclassified to 50) refers to fungicides having a mode of action that inhibits the growth of mycelium in fungi. Aryl-phenyl ketone fungicides include benzophenones such as metrafenone, and benzoylpyridines such as pyriofenone.

As used herein, “host plant defense induction fungicides (b51)” induce host plant defense mechanisms. Host plant defense induction fungicides include benzothiadiazole (FRAC code P01), benzisothiazole (FRAC code P02), thiadiazole carboxamide (FRAC code P03), polysaccharide (FRAC code P04), plant extract (FRAC code P05), microbial (FRAC code P06) and phosphonate fungicides (FRAC code P07, see (b33) above). The benzothiadiazoles include acibenzolar-S-methyl. The benzisothiazoles include probenazole. The thiadiazole carboxamides include tiadinil and isotianil. The polysaccharides include laminarin. The plant extracts include extract from Reynoutria sachalinensis (giant knotweed). The microbials include Bacillus mycoides isolate J and cell walls of Saccharomyces cerevisiae strain LAS117.

As used herein, “multi-site activity fungicides (b52)” refers to fungicides having a mode of action that inhibits fungal growth through multiple sites of action and have contact/preventive activity. Multi-site activity fungicides include copper fungicides (FRAC code M01), sulfur fungicides (FRAC code M02), dithiocarbamate fungicides (FRAC code M03), phthalimide fungicides (FRAC code M04), chloronitrile fungicides (FRAC code M05), sulfamide fungicides (FRAC code M06), multi-site contact guanidine fungicides (FRAC code M07), triazine fungicides (FRAC code M08), quinone fungicides (FRAC code M09), quinoxaline fungicides (FRAC code M10), maleimide fungicides (FRAC code M11) and thiocarbamate (FRAC code M12, see (b42) above) fungicides. Copper fungicides are inorganic compounds containing copper, typically in the copper(II) oxidation state; examples include copper oxychloride, copper sulfate and copper hydroxide, including compositions such as Bordeaux mixture (tribasic copper sulfate). Sulfur fungicides are inorganic chemicals containing rings or chains of sulfur atoms; examples include elemental sulfur. Dithiocarbamate fungicides contain a dithiocarbamate molecular moiety; examples include ferbam, mancozeb, maneb, metiram, propineb, thiram, zinc thiazole, zineb and ziram. Phthalimide fungicides contain a phthalimide molecular moiety; examples include folpet, captan and captafol. Chloronitrile fungicides contain an aromatic ring substituted with chloro and cyano; examples include chlorothalonil. Sulfamide fungicides include dichlofluanid and tolyfluanid. Multi-site contact guanidine fungicides include, guazatine, iminoctadine albesilate and iminoctadine triacetate. Triazine fungicides include anilazine. Quinone fungicides include dithianon. Quinoxaline fungicides include quinomethionate (also known as chinomethionate). Maleimide fungicides include fluoroimide.

As used herein, “biologicals with multiple modes of action (b53)” include agents from biological origins showing multiple mechanisms of action without evidence of a dominating mode of action. This class of fungicides includes polypeptide (lectin), phenol, sesquiterpene, tritepenoid and coumarin fungicides (FRAC code BM01) such as extract from the cotyledons of lupine plantlets. This class also includes microbial fungicides (FRAC code BM02, see (b44) above).

As used herein, “fungicides other than fungicides (b1) through (b53); (b54)”; include certain fungicides whose mode of action may be unknown. These include: (b54.1) “phenyl-acetamide fungicides” (FRAC code U06), (b54.2) “guanidine fungicides” (FRAC code U12), (b54.3) “thiazolidine fungicides” (FRAC code U13), (b54.4) “pyrimidinone-hydrazone fungicides” (FRAC code U14), (b54.5) “4-quinolylacetate fungicides” (FRAC code U16), (54.6) “tetrazolyloxime fungicides” (FRAC code U17) and “glucopyranosyl antibiotic fungicides” (FRAC code U18, see (b26) above). The phenyl-acetamides include cyflufenamid. The guanidines include dodine. The thiazolidines include flutianil. The pyrimidinonehydrazones include ferimzone. The 4-quinolylacetates include tebufloquin. The tetrazolyloximes include picarbutrazox.

The (b54) class also includes bethoxazin, dichlobentiazox (provisional common name, Registry Number 957144-77-3), dipymetitrone (provisional common name, Registry Number 16114-35-5), flometoquin, neo-asozin (ferric methanearsonate), pyrrolnitrin, tolnifanide (Registry Number 304911-98-6), N-[4-[4-chloro-3-(trifluoromethyl)-phenoxy]-2,5-dimethylphenyl]-N-ethyl-N-methylmethanimidamide, 5-fluoro-2-[(4-fluoro-phenyl)methoxy]-4-pyrimidinamine and 4-fluorophenyl N-[1-[[[1-(4-cyanophenyl)ethyl]-sulfonyl]methyl]propyl]carbamate.

Additional “Fungicides other than fungicides of classes (1) through (54)” whose mode of action may be unknown, or may not yet be classified include a fungicidal compound selected from components (b54.7) through (b54.11), as shown below.

Component (54.7) relates to (1S)-2,2-bis(4-fluorophenyl)-1-methylethyl N-[[3-(acetyloxy)-4-methoxy-2-pyridinyl]carbonyl]-L-alaninate (provisional common name florylpicoxamid, Registry Number 1961312-55-9) which is believed to be a Quinone inside inhibitor (QiI) fungicide (FRAC code 21) inhibiting the Complex III mitochondrial respiration in fungi.

Component (54.8) relates to 1-[2-[[[1-(4-chlorophenyl)-1H-pyrazol yl]oxy]methyl]-3-methylphenyl]-1,4-dihydro-4-methyl-5H-tetrazol-5-one (provisional common name metyltetraprole, Registry Number 1472649-01-6), which is believed to be a quinone outside inhibitor (QoI) fungicide (FRAC code 45) inhibiting the Complex III mitochondrial respiration in fungi, and is effective against QoI resistant strains.

Component (54.9) relates to 3-chloro-4-(2,6-difluorophenyl)-6-methyl-5-phenylpyridazine (provisional common name pyridachlometyl, Registry Number 1358061-55-8), which is believed to be promoter tubulin polymerization, resulting antifungal activity against fungal species belonging to the phyla Ascomycota and Basidiomycota.

Component (54.10) relates to (4-phenoxyphenyl)methyl 2-amino-6-methyl-pyridine-3-carboxylate (provisional common name aminopyrifen, Registry Number 1531626-08-0) which is believed to inhibit GWT-1 protein in glycosylphosphatidylinositol-anchor biosynthesis in Neurospora crassa.

Salts of any of (b1) to (b54) are included within the scope of the present disclosure.

Optional Pesticides

In some embodiments, the agricultural compositions may further comprise one or a combination of a further pesticide such as, for instance, a microbial insecticide, a chemical insecticide, a nematicide, a bacteriocide, a plant growth regulator, and a plant growth promotor.

Optional insecticides include: AO) various insecticides, including agrigata, aluminum phosphide, Amblyseius, Aphelinus, Aphidius, Aphidoletes, artimisinin, Autographa californica NPV, azocyclotin, Bacillus subtilis, Bacillus thuringiensis spp. aizawai, Bacillus thuringiensis spp. kurstaki, Bacillus thuringiensis, Beauveria bassiana, beta-cyfluthrin, bisultap, brofluthrinate, bromophos-e, bromopropylate, capsaicin, cartap, celastrus-extract, chlorbenzuron, chlorethoxyfos, chlorfluazuron, cnidiadin, cryolite, cyanophos, cyhalothrin, cyhexatin, cypermethrin, dacnusa, DCIP, dichloropropene, dicofol, diglyphus, diglyphus+dacnusa, dimethacarb, emamectin, encarsia, EPN, eretmocerus, ethylene-dibromide, eucalyptol, fenazaquin, fenobucarb (BPMC), fenpyroximate, flubrocythrinate, flufenzine, formetanate, formothion, furathiocarb, gamma-cyhalothrin, garlic-juice, granulosis-virus, harmonia, heliothis armigera NPV, indol-3-ylbutyric acid, iodomethane, iron, isocarbofos, isofenphos, isofenphos-m, isoprocarb, isothioate, lindane, liuyangmycin, matrine, mephosfolan, metaldehyde, metarhizium-anisopliae, methamidophos, metolcarb (MTMC), mirex, misothiocyanate, monosultap, myrothecium verrucaria, naled, Neochrysocharis formosa, nicotine, nicotinoids, omethoate, orius, oxymatrine, paecilomyces, parathion-e, pasteuria, pheromones, phosphorus-acid, photorhabdus, phoxim, Phytoseiulus, pirimiphos-e, Plutella xylostella GV, polyhedrosis-virus, polyphenol-extracts, potassium-oleate, profenofos, prosuler, prothiofos, pyraclofos, pyrethrins, pyridaphenthion, pyrimidifen, pyriproxifen, quillay-extract, quinomethionate, rotenone, saponin, saponozit, sodium-fluosilicate, sulfuramid, sulphur, tebupirimfos, tefuthrin, temephos, tetradifon, thiofanox, thiometon, transgenics (e.g., Cry3Bb1), triazamate, trichoderma, trichogramma, triflumuron, verticillium, vertrine, kappa-bifenthrin, kappa-tefluthrin, dichoromezotiaz, and broflanilide; A1) the class of carbamates, including aldicarb, alanycarb, benfuracarb, carbaryl, carbofuran, carbosulfan, methiocarb, methomyl, oxamyl, pirimicarb, propoxur and thiodicarb; A2) the class of organophosphates, including acephate, azinphos-ethyl, azinphosmethyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon; A3) the class of cyclodiene organochlorine compounds such as endosulfan; A4) the class of fiproles, including ethiprole, fipronil, pyrafluprole and pyriprole; A5) the class of neonicotinoids, including acetamiprid, clothianidin, dinotefuran, imidacloprid, nitenpyram, thiacloprid and thiamethoxam; A6) the class of spinosyns such as spinosad and spinetoram; A7) chloride channel activators from the class of mectins, including abamectin, emamectin benzoate, ivermectin, lepimectin and milbemectin; A8) juvenile hormone mimics such as hydroprene, kinoprene, methoprene, fenoxycarb and pyriproxyfen; A9) selective homopteran feeding blockers such as pymetrozine, flonicamid and pyrifluquinazon; A10) mite growth inhibitors such as clofentezine, hexythiazox and etoxazole; A11) inhibitors of mitochondrial ATP synthase such as diafenthiuron, fenbutatin oxide and propargite; uncouplers of oxidative phosphorylation such as chlorfenapyr; A12) nicotinic acetylcholine receptor channel blockers such as bensultap, cartap hydrochloride, thiocyclam and thiosultap sodium; A13) inhibitors of the chitin biosynthesis type 0 from the benzoylurea class, including bistrifluron, diflubenzuron, flufenoxuron, hexaflumuron, lufenuron, novaluron and teflubenzuron; A14) inhibitors of the chitin biosynthesis type 1 such as buprofezin; A15) moulting disruptors such as cyromazine; A16) ecdyson receptor agonists such as methoxyfenozide, tebufenozide, halofenozide and chromafenozide; A17) octopamin receptor agonists such as amitraz; A18) mitochondrial complex electron transport inhibitors pyridaben, tebufenpyrad, tolfenpyrad, flufenerim, cyenopyrafen, cyflumetofen, hydramethylnon, acequinocyl or fluacrypyrim; A19) voltage dependent sodium channel blockers such as indoxacarb and metaflumizone; A20) inhibitors of the lipid synthesis such as spirodiclofen, spiromesifen and spirotetramat; A21) ryanodine receptor-modulators from the class of diamides, including flubendiamide, the phthalamide compounds (R)-3-Chlor-N1-{2-methyl-4-[1,2,2,2-tetrafluor-1-(trifluormethyl)ethyl]phenyl}N2-(1-methyl-2-methylsulfonylethyl)phthalamid and (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, chlorantraniliprole and cyantraniliprole; A22) compounds of unknown or uncertain mode of action such as azadirachtin, amidoflumet, bifenazate, fluensulfone, piperonyl butoxide, pyridalyl, sulfoxaflor; or A23) sodium channel modulators from the class of pyrethroids, including acrinathrin, allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin. Salts thereof are included within the scope of the present disclosure.

Optional nematicides include: C1) benomyl, cloethocarb, aldoxycarb, tirpate, diamidafos, fenamiphos, cadusafos, dichlofenthion, ethoprophos, fensulfothion, fosthiazate, heterophos, isamidofos, isazofos, phosphocarb, thionazin, imicyafos, mecarphon, acetoprole, benclothiaz, chloropicrin, dazomet, fluensulfone, 1,3-dichloropropene (telone), dimethyl disulfide, metam sodium, metam potassium, metam salt (all MITC generators), methyl bromide, biological soil amendments (e.g., mustard seeds, mustard seed extracts), allyl isothiocyanate (AITC), dimethyl sulfate, furfual (aldehyde). Salts thereof are included within the scope of the present disclosure.

Optional plant growth regulators include: D1) antiauxins, such as clofibric acid, and 2,3,5-tri-iodobenzoic acid; D2) auxins such as 4-CPA, 2,4-D, 2,4-DB, 2,4-DEP, dichlorprop, fenoprop, IAA, IBA, naphthaleneacetamide, ct-naphthaleneacetic acids, 1-naphthol, naphthoxyacetic acids, potassium naphthenate, sodium naphthenate, and 2,4,5-T; D3) cytokinins, such as 2iP, benzyladenine, 4-hydroxyphenethyl alcohol, kinetin, and zeatin; D4) defoliants, such as calcium cyanamide, dimethipin, endothal, ethephon, merphos, metoxuron, pentachlorophenol, thidiazuron, and tribufos; D5) ethylene inhibitors, such as aviglycine, and 1-methylcyclopropene; D6) ethylene releasers, such as ACC, etacelasil, ethephon, and glyoxime; D7) gametocides, such as fenridazon, and maleic hydrazide; D8) gibberellins, such as gibberellins, and gibberellic acid; D9) growth inhibitors, such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, tiaojiean, and 2,3,5-tri-iodobenzoic acid; D10) morphactins, such as chlorfluren, chlorflurenol, dichlorflurenol, and flurenol; D11) growth retardants, such as chlonnequat, daminozide, flurprimidol, mefluidide, paclobutrazol, tetcyclacis, and uniconazole; D12) growth stimulators, such as brassinolide, brassinolide-ethyl, DCPTA, forchlorfenuron, hymexazol, prosuler, and triacontanol; D13) unclassified plant growth regulators, such as bachmedesh, benzofluor, buminafos, carvone, choline chloride, ciobutide, clofencet, cyanamide, cyclanilide, cycloheximide, cyprosulfamide, epocholeone, ethychlozate, ethylene, fuphenthiourea, furalane, heptopargil, holosulf, inabenfide, karetazan, lead arsenate, methasulfocarb, prohexadione, pydanon, sintofen, triapenthenol, and trinexapac. Salts thereof are included within the scope of the present disclosure.

Adjuvants

Compositions of the present disclosure comprise a liquid or solid carrier, as well as one or more additional components selected from surface-active agents, oils, preservatives, humectants, desiccants, anti-foam agents, anti-freeze agents, dispersants, binders, emulsifiers, dyes, ultraviolet light protectants, drift-control agents, spray deposition aids, free-flow agents, buffers, and thickeners, and combinations thereof.

Non-limiting examples of liquid carriers include water, animal oils and derivatives, mineral oils and derivatives, vegetable oils and derivatives, solvents, alcohols, polyols, triglycerides, natural and synthetic polymers, and combinations thereof.

Non-limiting examples of solid carriers include minerals, clays, silica, inorganic and organic salts, sugars, starches, waxes, ground animal shells, and botanical material including fibers, husks shells and flour.

Non-limiting examples of surface-active agents include non-ionic, cationic, anionic and amphoteric surfactants such as, for instance, condensation product of formaldehyde with naphthalene sulphonate, alkylarylsulphonate (e.g., dodecylbenzylsulfonate type), lignin sulphonate (sodium lignosulfate), fatty alkyl sulphate, ethoxylated alkylphenol, ethoxylated fatty alcohol (e.g., ethoxylated C₁₂₋₂₂ fatty alcohols having a degree of ethoxylation of from 5 to 40), alkyl esters of C₈₋₂₂ fatty acids such as methyl derivatives of C₁₂₋₁₈ fatty acids (e.g., methyl esters of lauric acid, palmitic acid and oleic acid), and silicone surfactants (e.g., polyalkyl-oxide-modified heptamethyltrisiloxanes). When present, the surface active agent concentration may suitably be about 1 wt. %, about 2 wt. %, about 3 wt. %, about 4 wt. %, about 5 wt. %, about 10 wt. %, about 15 wt. %, about 20 wt. %, about 25 wt. %, or about 30 wt. %, and any range constructed therefrom, such as from about 1 wt. % to about 30 wt. %, from about 1 wt. % to about 20 wt. %, from about 5 wt. % to about 20 wt. %, or from about 1 wt. % to about 5 wt. %.

Non-limiting examples of oils include oils of vegetable or animal origin, a mineral oil, alkyl esters of such oils or mixtures of such oils and oil derivatives. In some aspects, the oil may be of vegetable origin, for example, rapeseed oil, olive oil or sunflower oil, emulsified vegetable oil. In some aspects, the oil may be of animal origin, for instance, fish oil or beef tallow. Alkyl esters of oils of vegetable origin and/or of animal origin are also within the scope of the present disclosure, for example, methyl derivatives such as methylated rapeseed oil and methylated fish oil. Alkyl esters of fatty acids are also within the scope of the present disclosure, such as C₈₋₂₂ fatty acids such as methyl derivatives of C₁₂₋₁₈ fatty acids, for example, the methyl esters of lauric acid, palmitic acid and oleic acid.

Non-limiting examples of solvents include aromatic solvents (for example aromatics (e.g., Solvesso^{RTm}), paraffins (for example mineral fractions), alcohols (e.g., methanol, butanol, pentanol, or benzyl alcohol), ketones (e.g., cyclohexanone or gamma-butyrolactone), pyrrolidones (e.g., N-methyl pyrrolidone or N-octyl-2-pyrrolidone), DMSO, and acetates (e.g., glycol diacetate).

Formulations

The compositions of the disclosure may be employed in any conventional form, for example in the form, a powder for dry seed treatment (DS), an emulsion for seed treatment (ES), a flowable concentrate for seed treatment (FS), a solution for seed treatment (LS), wettable powders (WP), a water dispersible powder for seed treatment (WS), dustable powders (DP), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), a water dispersible granule (WT), an emulsifiable granule (EG), an emulsion, water in oil (EO), an emulsion, oil in water (EW), a paste (PA), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP), a soluble granule (SG) or any technically feasible formulation in combination with agriculturally acceptable adjuvants.

In some aspects, the composition may be in the form of a formulation selected from suspensions, suspension concentrates (SC), oil dispersions (OD), foams, dustable powders (DP), water-dispersible granules (WG) and wettable powders (WP).

In some aspects, the composition may be in the form of a liquid formulation selected from suspensions, suspension concentrates (SC), oil dispersions (OD) and foams.

In some aspects, the composition may be in the form of a tank mix or a premix.

In some aspects, composition may be in solid form. Solid forms include dustable powders (DP), water-dispersible granules (WG) and wettable powders (WP).

In any of the various aspects of the present disclosure, the ratio of B. amyloliquefaciens, e.g. B. amyloliquefaciens FCC1256, to SDHI, e.g. fluindapyr, is suitably about 1×10⁷ CFU per g a.i., about 5×10⁷ CFU per g a.i., about 1×10⁸ CFU per g a.i., about 2.5×10⁸ CFU per g a.i., about 5×10⁸ CFU per g a.i., about 7.5×10⁸ CFU per g a.i., about 1×10⁹ CFU per g a.i., about 2.5×10⁹ CFU per g a.i., about 5×10⁹ CFU per g a.i., about 7.5×10⁹ CFU per g a.i., about 1×10¹⁰ CFU per g a.i., about 5×10¹⁰ CFU per g a.i., about 1×10¹⁰ CFU per g a.i., about 5×10¹⁰ CFU per g a.i., about 1×10¹¹ CFU per g a.i., about 5×10¹¹ CFU per g a.i., about 1×10¹² CFU per g a.i., about 5×10¹² CFU per g a.i., about 1×10¹³ CFU per g a.i., about 5×10¹³ CFU per g a.i., about 1×10¹⁴ CFU per g a.i., about 5×10¹⁴ CFU per g a.i., about 1×10¹⁵ CFU per g a.i., or about 5×10¹⁵ CFU per g a.i., and any range constructed therefrom, such as from about 1×10⁷ CFU per g a.i. to about 5×10¹⁵ CFU per g a.i., from about 1×10⁷ CFU per g a.i. to about 1×10¹⁴ CFU per g a.i., from about 1×10⁷ CFU per g a.i. to about 1×10¹³ CFU per g a.i., from about 1×10⁷ CFU per g a.i. to about 1×10¹² CFU per g a.i., from about 5×10⁷ CFU per g a.i. to about 5×10¹¹ CFU per g a.i., from about 1×10⁸ CFU per g a.i. to about 1×10¹¹ CFU per g a.i., from about 5×10⁸ CFU per g a.i. to about 5×10¹⁰ CFU per g a.i., or from about 1×10⁹ CFU per g a.i. to about 1×10¹⁰ CFU per g a.i.

In solid form aspects of the disclosure, the B. amyloliquefaciens, e.g. B. amyloliquefaciens FCC1256, may be present in a concentration of about 1×10⁶ CFU/g, about 5×10⁶ CFU/g, about 1×10⁷ CFU/g, about 5×10⁷ CFU/g, about 1×10⁸ CFU/g, about 5×10⁸ CFU/g, about 1×10⁹ CFU/g, about 5×10⁹ CFU/g, about 1×10¹⁰ CFU/g, about 5×10¹⁰ CFU/g, about 1×10¹¹CFU/g, about 5×10¹¹ CFU/g or about 1.0×10¹² CFU/g, and any range constructed therefrom, such as from about 1×10⁶ CFU/g to about 1×10¹² CFU/g, from about 1×10⁷ CFU/g to about 1×10¹¹ CFU/g, or from about 1×10⁸ CFU/g to about 1×10¹⁰ CFU/g.

In liquid form aspects of the disclosure, the B. amyloliquefaciens, e.g. B. amyloliquefaciens FCC1256, may be present in a concentration of about 1×10⁶ CFU/mL, about 5×10⁶ CFU/mL, about 1×10⁷ CFU/mL, about 5×10⁷ CFU/mL, about 1×10⁸ CFU/mL, about 5×10⁸ CFU/mL, about 1×10⁹ CFU/mL, about 5×10⁹ CFU/mL, about 1×10¹⁰ CFU/mL, about 5×10¹⁰ CFU/mL, about 1×10¹¹CFU/mL, about 5×10¹¹ CFU/mL or about 1.0×10¹² CFU/mL, and any range constructed therefrom, such as from about 1×10⁶ CFU/mL to about 1×10¹² CFU/mL, from about 1×10⁷ CFU/mL to about 1×10¹¹ CFU/mL, or from about 1×10⁸ CFU/mL to about 1×10¹⁰ CFU/mL.

In some aspects, B. amyloliquefaciens may suitably be included in formulations of the present disclosure in the form of spores thereof or in the form of vegetative cells. For example, the formulations may include an aliquot of a fermentation broth comprising spores of B. amyloliquefaciens or a processed fermentation product comprising spores of B. amyloliquefaciens, such as a concentrate of a fermentation broth or a spray-dried fermentation broth.

Plants

In some aspects of the present disclosure, the plant is selected from one or more of: Alysicarpus (Alysicarpus glumaceus, Alysicarpus nummularifolius, Alysicarpus rugosus, Alysicarpus vaginalis), such as Alyce clover; Cajanus cajan, e.g., Cajan, pigeon pea; Canavalia gladiate, i.e., Swordbean; Centrosema pubescens, e.g., Butterfly pea; Clitoria termatea, e.g., Kordofan pea, butterfly pea, Asian pigeon wings; Coronilia varia, e.g., Crownvetch; Crotalaria (Crotalaria anagyroides, Crotalaria saltiana), e.g., Rattlebox; Delonix regia, e.g., Poinciana, royal Poinciana; Desmodium triflorum, e.g., Three-flower beggarweed; Glycine (Glycine canescens, Glycine clandestine, Glycine clandestine, Glycine falcadata, Glycine max, Glycine soja, Glycine tabacina), soybean and soybean relatives; Lablab purpureus, e.g., Lablab, hyacinth bean; Lespedeza (Lespedeza bicolor, Lespedeza striata, Lespedeza stipulaceae), Lupinus (Lupinus albus, Lupinus angustifolius, Lupinus hirsutus, Lupinus luteus), Lupines, White lupine, Narrow-leaved lupine, Blue lupine, Yellow lupine; Macroptilium atropurpurem, e.g., Siratro, purple bean siratro; Macrotyloma axilare; Medicago (Medicago arborea, Medicago lupulina) Medic, Black medic; Melilotus officinalis, Yellow sweet clover; Mucuna (Mucuna cochinchinesis), velvetbean, velvetbean relative; Neonotonia (glycine) wrightii; Pachyrhizus (Pachyrhizus ahipa, Pachyrhizus erosus), e.g., Yam bean, Jicama, chop suey bean; Phaseolus (Phaseolus lunatus, Phaseolus vulgaris), e.g., butter bean, lima bean, kidney bean, green bean; Pisum sativum, peas (green); Psophocarpus tetragonolobus, winged bean or Goa; Senna (Senna obtusifolia, Senna occidentalis), e.g., sickpod, coffee senna; Sesbania (Sesbania exaltada, Sesbania macrocarp, Sesbania vescaria), e.g., Colorado River hemp, hemp sesbania, coffeebean, peatree; Trifolium (Trifolium repens, Trifolium incarnatum), e.g., white clover, crimson clover; Trigonella (Trigonella foenum-graicum, Trigonella foenum-gracecum), e.g., Fenugreek; Vicia (Vicia angustifolia, Vicia dasycarpa, Vicia faba, Vicia narbonensis, Vicia villosa), e.g., narrow-leaf vetch, wooly-pod vetch, broadbean, fava bean, broad-leaved vetch, woolypod vetch; Vigna (Vigna mungo, Vigna radiate, Vigna unguiculata), e.g., urd, black gram, mung bean, cowpea, black-eye pea, yearlong bean; and Voandzeia subterranean, Bambara groundnut. In some aspects the plant is of the genus Glycine. In some aspects, the plant is Glycine max (soybean). When the plant is of the genus Glycine, one relevant phytopathogenic fungi is of the genus Phakopsora. In some other aspect the plant is a cereal, like wheat, barley, rye, oat, triticale, sorghum, rice or corn (maize). When the plant is a cereal, one relevant phytopathogenic fungi is of the genus Puccinia.

Methods

In at least one aspect of the present methods, the composition is applied to the plant, to a part of the plant and/or to a locus at which the plant or plant part grows or is to be planted, e.g., foliage of the plant, bark of the plant, fruit of the plant, flowers of the plant, seed of the plant, roots of the plant, a cutting of the plant, a graft of the plant, soil or growth medium surrounding the plant; soil or growth medium before sowing seeds of the plant in the soil or growth medium; or soil or growth medium before planting the plant, the plant cutting, or the plant graft in the soil or growth medium.

In one aspect, the disclosure relates to a method of controlling fungal plant pathogen(s) and/or bacterial plant pathogen(s) on a plant, the method comprising applying a composition of the present disclosure to over-ground parts of the plant.

Applying a composition of the present disclosure to a part of the plant and/or to a locus at which the plant or plant part grows or is to be planted may be accomplished by any conventional means, e.g. by spray application, by dripping, by powdering (powder application), by application of a foam (foam application), etc.

For applications to the soil around the plant, spray application, application by dripping, powder application and foam application may be interesting. In one aspect, application to the soil around a plant is by in-furrow application by dripping or foam application in connection with seed planting.

In some aspects, the composition is applied such that the rate of Bacillus amyloliquefaciens, e.g. B. amyloliquefaciens FCC1256, is in the range of from 4.0×10⁹ CFU/ha to 4.0×10¹⁷ CFU/ha, such as 4.0×10¹⁰ CFU/ha to 4.0×10¹⁶ CFU/ha. In some aspects, the Bacillus amyloliquefaciens may be applied in the form of spores thereof, rather than vegetative cells.

Agricultural formulations can be obtained by proper dilution of the concentrates with a suitable liquid carrier as described elsewhere herein, such as an aqueous carrier. Typically, dilution is at a concentrate-to-carrier weight ratio of from 1:10 to 1:5000, such as from 1:20 to 1:1000.

In a particular aspect is provided a method for controlling phytopathogenic fungi selected from the group consisting of Phakopsora pachyrhizi and Phakopsora meibomiae, wherein the method comprises treating plants, plant propagation material, and/or associated soil with a pesticidal composition comprising an effective amount of: (1) a Bacillus amyloliquefaciens fungicide component comprising a population of at least one strain of Bacillus amyloliquefaciens; and (2) a second fungicide component comprising at least one fungicide selected from the group consisting of succinate dehydrogenase inhibitors. The population of the Bacillus amyloliquefaciens contained in the Bacillus amyloliquefaciens fungicide component and the second fungicide component are preferably present in a ratio of from about 1×10⁷ CFU Bacillus amyloliquefaciens per gram succinate dehydrogenase inhibitor active ingredient to about 1×10¹⁵ CFU Bacillus amyloliquefaciens per gram succinate dehydrogenase inhibitor active ingredient. In some interesting variants hereof, the second fungicide component is selected from the group consisting of benodanil, flutolanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypram, pyriflumetofen, boscalid, pyraziflumid, salts thereof, and combinations thereof, such as from the group consisting of benzovindiflupyr, bixafen, fluindapyr, fluxapyroxad, furametpyr, inpyrfluxam, isopyrazam, penflufen, penthiopyrad, sedaxane, salts thereof, and combinations thereof. In other interesting variants hereof, the second fungicide component is selected from a phenyl-benzamide, a phenyl-oxo-ethyl thiophene amide, a pyridinyl-ethyl benzamide, a furan carboxamide, an oxathiin carboxamide, a thiazole carboxamide, a pyrazole-4-carboxamide, an N-cyclopropyl-N-benzyl-pyrazole carboxamide, a pyridine carboxamide, and a pyrazine carboxamide, and salts thereof, such as a pyrazole-4-carboxamide or a salt thereof. In further interesting variants, the second fungicide component is fluindapyr or a salt thereof.

In some embodiments hereof, the B. amyloliquefaciens strain, like for B. amyloliquefaciens FCC1256, produces iturin and fengycin in the relative weight ratio of from 0.8:1.0 to 5.0:1.0, such as from 1.0:1.0 to 4.0:1.0, e.g. from 1.3:1.0 to 3.0:1.0.

In alternative embodiment, and based on the results reported herein, it is speculated that selected other fungicides like chlorothalonil, fluxapyroxad, azoxystrobin, picoxystrobin and copper oxychloride, may utilized as described for SDHIs (e.g. fluindapyr) in combination with B. amyloliquefaciens FCC1256, either as an alternative to the SDHIs (mutatis mutandis), or in addition to the SDHIs.

### EXAMPLES

Methods

Severity was evaluated as percentage of leaf surface with rust according to the method described by Godoy at al., “Diagrammatic Scale for Assessment of Soybean Rust Severity”, Fitopatol. Bras. 31(1), jan-fev 2006, pp. 63-68. Unless otherwise stated, results were subjected to the analysis of variance (Anova), and statistical analysis was done using the Scott-Knott method at 95% confidence.

Efficacy (% control) was calculated using formula:

% control=100*(1−% Severity (Treated)/% Severity (untreated))

### Example 1—Synergy Between B. amyloliquefaciens FCC1256 (Deposited as ATCC No. PTA-122162) and Fluindapyr and Between B. amyloliquefaciens FCC1256 and Chlorothalonil Against Asian Soybean Rust was Evaluated

In a trial, 15-day old soybean plantlets at V1 stage (BBCH) were produced in a greenhouse, selected, had apical shoots trimmed, and were labeled for product spray. Fungicidal formulations of Table 1 were applied by spraying at a rate of 200 L/ha to selected soybean plantlets using a spray cabin with a mobile a hollow cone spray nozzle positioned 30 cm from the plants. After spraying, the plants were held at room temperature for 2 hours before being transferred to Conviron Growth chambers, and thereafter held at conditions of: alternating at 25±2° C. during the day and 20±2° C. at night; RH 80±10%; and a photoperiod of 12 h/12 h light/dark. After one day in the growth chamber, the plants were inoculated with Asian soybean rust (P. pachyrhizi) spores (100,000 spores/mL) then held in the growth chamber for 14 days. After 14 days, the plants were evaluated for crop response (=phytotoxicity) and efficacy.

The formulations in Table 1 below were prepared and evaluated against P. pachyrhizi according to the above method.

TABLE 1

| | | | | Ad- |
|---|---|---|---|---|
| Form. | B. amyloliquefaciens | Fluindapyr | Chlorothalonil | juvant |
| 1 | Untreated control | | | |
| 2 | 2 × 10¹¹ CFU/ha | — | — | — |
| 3 | 2 × 10¹¹ CFU/ha | — | — | 8.5 |
| 4 | 2 × 10¹¹ CFU/ha | — | — | 14.5 |
| 5 | 2 × 10¹¹ CFU/ha | — | — | 16.9 |
| 6 | 2 × 10¹¹ CFU/ha | — | — | Ziel |
| 7 | — | 80 g a.i./ha | 1000 g a.i./ha | — |
| 8 | 2 × 10¹¹ CFU/ha | 40 g a.i./ha | 500 g a.i./ha | — |
| 9 | 2 × 10¹¹ CFU/ha | 60 g a.i./ha | 750 g a.i./ha | — |
| 10 | 2 × 10¹¹ CFU/ha | 80 g a.i./ha | 1000 g a.i./ha | — |
| 11 | 1 × 10¹¹ CFU/ha | 80 g a.i./ha | 1000 g a.i./ha | — |
| 12 | 2 × 10¹¹ CFU/ha | 80 g a.i./ha | 1000 g a.i./ha | Ziel |
| 13 | — | 80 g a.i./ha | 1000 g a.i./ha | Ziel |
| 14 | 2 × 10¹¹ CFU/ha | — | 1000 g a.i./ha | — |
| 15 | — | — | 1000 g a.i./ha | — |
| 16 | 2 × 10¹¹ CFU/ha | 80 g a.i./ha | — | — |
| 17 | — | 80 g a.i./ha | — | — |

P. pachyrhizi control on soybean plant was evaluated and the results are reported in Table 2 below. Formulation 18 was mancozeb (Unizeb™ Gold) and was applied at a rate of 1125 g a.i./ha.

TABLE 2

| Formulation | % Control |
|---|---|
| 1 | Untreated Control |
| 2 | 31.8^{d} |
| 3 | 25.8^{d} |
| 4 | 27.5^{d} |
| 5 | 32.4^{d} |
| 6 | 48.2^{c} |
| 7 | 96.7^{a} |
| 8 | 98.3^{a} |
| 9 | 98.3^{a} |
| 10 | 98.4^{a} |
| 11 | 95.4^{a} |
| 12 | 99.5^{a} |
| 13 | 99.4^{a} |
| 14 | 93.0^{a} |
| 15 | 89.7^{a} |
| 16 | 76.5^{b} |
| 17 | 31.2^{d} |
| 18 | 99.1a |

The mixture of B. amyloliquefaciens and fluindapyr (formulation 16) demonstrated a high synergistic effect at a % control of 76.5 versus an expected % control of 53 as calculated by the Colby equation for a % control of 31.8 (formulation 2) for B. amyloliquefaciens in the absence of fluindapyr and for a % control of 31.2 (formulation 17) for fluindapyr in the absence of B. amyloliquefaciens.

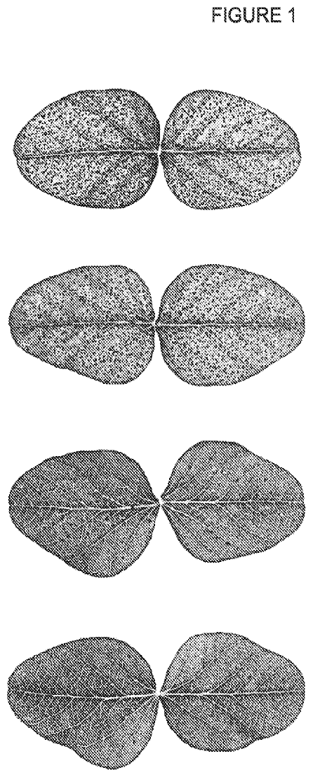

Results for the untreated control, formulation 2 (2×10¹¹ CFU/ha B. amyloliquefaciens), formulation 7 (80 g a.i./ha fluindapyr and 1000 g a.i./ha chlorothalonil), and formulation 10 (2×10¹¹ CFU/ha B. amyloliquefaciens, 80 g a.i./ha fluindapyr and 1000 g a.i./ha chlorothalonil) are shown in FIG. 1.

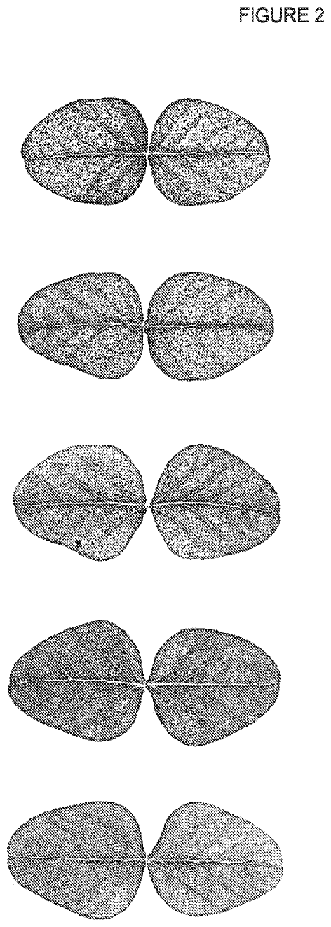

Results for the untreated control, formulation 2 (2×10¹¹ CFU/ha B. amyloliquefaciens), formulation 17 (80 g a.i./ha fluindapyr), formulation 16 (2×10¹¹ CFU/ha B. amyloliquefaciens and 80 g a.i./ha fluindapyr), and mancozeb control are shown in FIG. 2.

### Example 2—Synergy Between Bacillus amyloliquefaciens FCC1256 (F4028-B) and Fluindapyr (F9944-A) Against Asian Soybean Rust was Evaluated in a Set of Two Consecutive Growth Chamber Experiments

Two laboratory experiments were carried out to determine the effects of Fluindapyr alone and in combination with B. amyloliquefaciens FCC1256 against Asian Soybean Rust. Fluindapyr was evaluated inside a model EC formulation (F9944-A, 480 g fluindapyr/L) and the B. amyloliquefaciens FCC1256 strain was tested inside a model formulation (F4028-B, not containing any adjuvants, at a concentration of 1×10⁸ CFU/mL). In these trials, fifty-day-old soybean seedlings at VC stage (BMX Potencia RR variety) were produced in a greenhouse, selected, had apical shoots trimmed, and were labeled for product spray. Fungicide formulations tested solo or in combination as shown in Table 3 were applied on plantlets by spraying at a volume of 200 L/ha using a laboratory spray cabinet. Each formulation was represented by six replicates (1 replicate corresponding to 1 soybean seedlings). After spraying, the seedlings were held at room temperature for 2 hours. After that, all seedlings were transferred and held in a growth chamber at 25±2° C. during the day and 20±2° C. at night; RH 75±10%; and a photoperiod of 12 h/12 h light/dark. After one day in the growth chamber, the plants were inoculated with Phakopsora pachyrhizi spores (50,000 spores/mL) then held in the growth chamber for 14 days. After 14 days, the plants were evaluated for efficacy.

TABLE 3

| | Products/ | Products | | | Active ingredient |
|---|---|---|---|---|---|
| Form. | combinations | rates/ha | | Active ingredient | rates/ha |
| 1 | F4028-B | 2000 | mL | Bacillus amyloliquefaciens | 2 × 10¹¹ CFU |
| | | | | (FCC1256)* | |
| 2 | F4028-B | 1000 | mL | B. amyloliquefaciens (FCC1256)* | 1 × 10¹¹ CFU |
| 3 | F9944-A | 167 | mL | Fluindapyr | 80 g |
| 4 | F9944-A | 83 | mL | Fluindapyr | 40 g |
| 5 | F4028-B + F9944-A | 2000 mL + 167 mL | | Bacillus amyloliquefaciens | 2 × 10¹¹ CFU + |
| | | | | (FCC1256)* + Fluindapyr | 80 g |
| 6 | F4028-B + F9944-A | 2000 mL + 83 mL | | Bacillus amyloliquefaciens | 2 × 10¹¹ CFU + |
| | | | | (FCC1256)* + Fluindapyr | 40 g |
| 7 | F4028-B + F9944-A | 1000 mL + 167 mL | | Bacillus amyloliquefaciens | 1 × 10¹¹ CFU + |
| | | | | (FCC1256)* + Fluindapyr | 80 g |
| 8 | F4028-B + F9944-A | 1000 mL + 83 mL | | Bacillus amyloliquefaciens | 1 × 10¹¹ CFU + |
| | | | | (FCC1256)* + Fluindapyr | 40 g |
| 9 | Mancozeb 750 WG | 1500 | g | Mancozeb | 1125 g |

| | | | | |
|---|---|---|---|---|
| 10 | Untreated control | — | — | — |

*CFU/mL: 1.0 × 10⁸

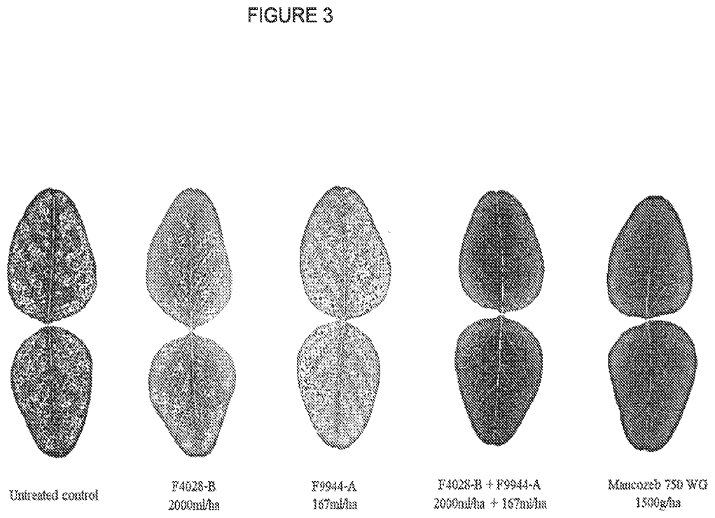

The Combination of F4028-B and F9944-A demonstrated a synergistic effect for the different rates tested (Table 4; and FIG. 3) when seedlings were inoculated one day after the product application.

TABLE 4

| | | | | % | % expected |
|---|---|---|---|---|---|
| Formu- | Products/ | | | observed | control |
| lation | combinations | Products rates/ha | | control | (Colby) |
| 1 | F4028-B | 2000 | mL | 28 c | — |
| 2 | F4028-B | 1000 | mL | 16 b | — |
| 3 | F9944-A | 167 | mL | 50 d | — |
| 4 | F9944-A | 83 | mL | 37 c | — |
| 5 | F4028-B + | 2000 mL + 167 mL | | 87 e | 64* |
| | F9944-A | | | | |
| 6 | F4028-B + | 2000 mL + 83 mL | | 79 e | 54* |
| | F9944-A | | | | |
| 7 | F4028-B + | 1000 mL + 167 mL | | 63 d | 58* |
| | F9944-A | | | | |
| 8 | F4028-B + | 1000 mL + 83 mL | | 56 d | 47* |
| | F9944-A | | | | |
| 9 | Mancozeb | 1500 | g | 100 f | — |
| | 750 WG | | | | |

| | | | | |
|---|---|---|---|---|
| 10 | Untreated | — | 0 a | — |
| | control | | | |

*Synergistic effect
Means followed by the same letter do not differ by Scott-Knott test at 5%

### Example 3—Synergistic Effect of Combined Application of Chemical Fungicides and F4028-B for Asian Soybean Rust Control

One laboratory experiment was carried out to determine the effect of chemical fungicides solo and in combination with B. amyloliquefaciens FCC1256 against Asian Soybean Rust. Chemical fungicides were evaluated as commercial products/formulation and the B. amyloliquefaciens FCC1256 strain was tested inside a model formulation (F4028-B not containing any adjuvants, concentration of 1.0×10⁸ CFU/mL. The formulations tested in solo or in combination as shown in Table 5 were tested and plants were evaluated for efficacy as described in Example 2.

TABLE 5

| | | | | Active |
|---|---|---|---|---|
| | | Product | | ingrediente |
| Form. | Products/combinations | rates/ha | Active ingrediente | rates/ha |
| 1 | Untreated control | — | — | — |
| 2 | F4028-B | 2000 mL | Bacillus amyloliquefaciens | 2 × 10¹¹ CFU |
| | | | (FCC1256) * | |
| 3 | FMF-Fluxapiroxade 6% EC | 935 mL | Fluxapyroxad | 58 g |
| 4 | Priori | 240 mL | Azoxystrobin | 60 g |
| 5 | Oranis | 250 mL | Picoxystrobin | 60 g |
| 6 | Difere | 500 mL | Copper oxychloride | 294 g |
| 7 | F4028-B + FMF-Fluxapiroxade | 2000 mL + 935 mL | B. amyloliquefaciens | 2 × 10¹¹ CFU + |
| | 6% EC | | (FCC1256) * + | 58 g |
| | | | Fluxapyroxad | |
| 8 | F4028-B + Priori | 2000 mL + 240 mL | B. amyloliquefaciens | 2 × 10¹¹ CFU + |
| | | | (FCC1256) * + | 60 g |
| | | | Azoxystrobin | |
| 9 | F4028-B + Oranis | 2000 mL + 250 mL | B. amyloliquefaciens | 2 × 10¹¹ + |
| | | | (FCC1256) * + | 60 g |
| | | | Picoxystrobin | |
| 10 | F4028-B + Difere | 2000 mL + 500 mL | B. amyloliquefaciens | 2 × 10¹¹ CFU + |
| | | | (FCC1256) * + Copper | 294 g |
| | | | oxychloride | |

* CFU/mL: 1.0 × 10⁸

According the results presented in the Table 6, the combination of B. amyloliquefaciens FCC1256 and FMF-Fluxapiroxade 6% EC, Priori, Oranis and Difere. (Combinations 7 to 10, Table 6) showed a synergistic effect.

TABLE 6

| | | Rates | | % expected |
|---|---|---|---|---|
| | | mL or g | % observed | control |
| Form. | Products/combinations | product/ha | control** | (Colby) |
| 1 | Untreated control | — | 0 a | — |
| 2 | F4028-B | 2000 mL | 50 b | — |
| 3 | FMF-Fluxapiroxade 6% EC | 935 mL | 73 c | — |
| 4 | Priori | 240 mL | 69 c | — |
| 5 | Oranis | 250 mL | 72 c | — |
| 6 | Difere | 500 mL | 41 b | — |
| 7 | F4028-B + FMF-Fluxapiroxade 6% EC | 2000 mL + 935 mL | 97 d | 87* |
| 8 | F4028-B + Priori | 2000 mL + 240 mL | 92 d | 84* |
| 9 | F4028-B + Oranis | 2000 mL + 250 mL | 98 d | 86* |
| 10 | F4028-B + Difere | 2000 mL + 500 mL | 76 c | 70* |

*Synergistic effect
**Means followed by the same letter do not differ by Scott-Knott test at 5%

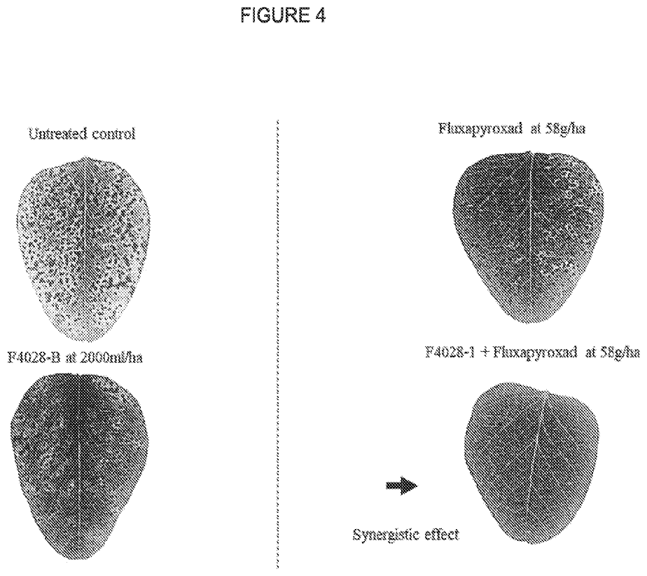

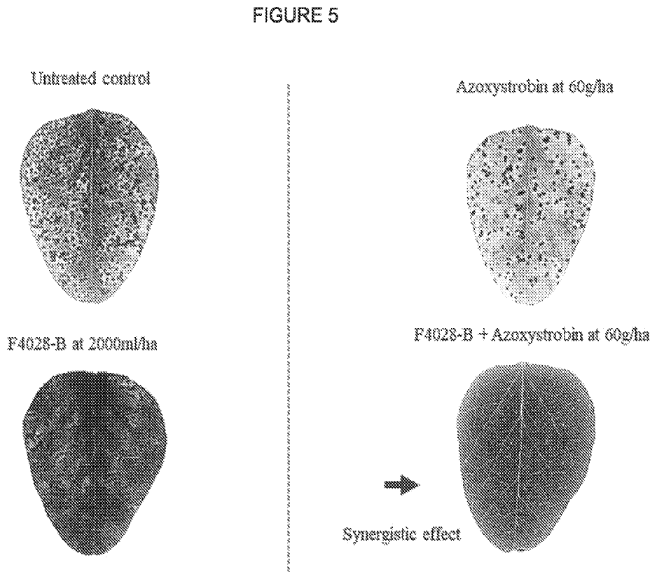

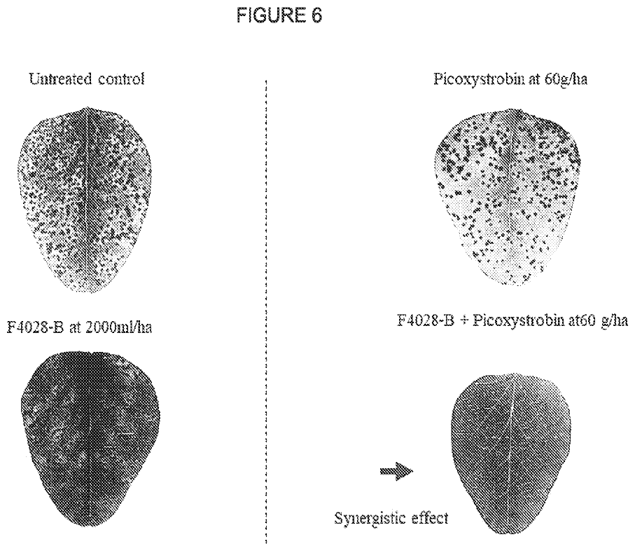

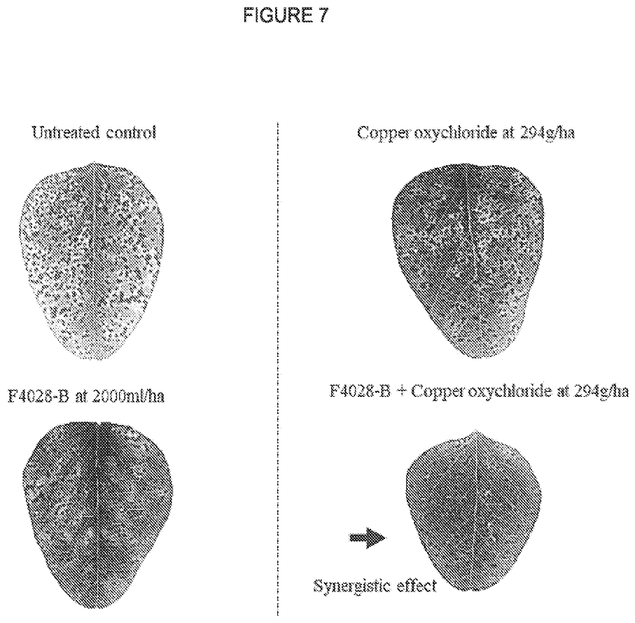

The combination between F4028-B and fungicides increased the efficacy of Asian Soybean Rust control for all combinations evaluated when compared with F4028-B and fungicides solos (Table 6). Results for the untreated control, formulation 2 (F4028-B at 2000 mL/ha), formulations with fungicides solo (Formulations 3 to 6, Table 6) and combined with F4028-B (Combinations 7 to 10, Table 6) are shown in FIGS. 4, 5, 6 and 7. This data showed evidences of F4028-B has a synergistic effect when in combination with chemical fungicides with different modes of action (SDHIs: Fluxapyroxad; Qols: Azoxystrobin and Picoxystrobin; and Multi-sites: Copper oxychloride).

### Example 4—Synergistic Effect of Combined Application of Fluindapyr and Bacillus amyloliquefaciens Strains for Asian Soybean Rust Control

One laboratory experiment was carried out to determine the effects of Fluindapyr alone and in combination with three B. amyloliquefaciens strains against Asian Soybean Rust. Bacillus amyloliquefaciens MB1660 and D747 strains were evaluated as commercial products/formulation, Duravel and Eco-shot, respectively. The Bacillus amyloliquefaciens FCC1256 strain was tested inside a model formulation (F4028-B, not containing any adjuvants). The formulations tested in solo or in combination as shown in Table 7 were tested and plants were evaluated for efficacy as described in Example 2.

TABLE 7

| | | Active ingredients | | | Active |
|---|---|---|---|---|---|
| | Products/ | Bacillus | | | ingredientes |
| Form. | Combinations | amyloliquefaciens (strain) | Product rates/ha | | rates/ha |
| 1 | Untreated control | — | — | | — |
| 2 | F9944-A | — | 167 | mL | 80 g |
| 3 | F4028-B | FCC1256* | 1000 | mL | 1 × 10¹¹ CFU |
| 4 | F4028-B | FCC1256 | 2000 | mL | 2 × 10¹¹ CFU |
| 5 | F4028-B + F9944-A | FCC1256 + Fluindapyr | 1000 mL + 167 mL | | 1 × 10¹¹ CFU |
| 6 | F4028-B + F9944-A | FCC1256 + Fluindapyr | 2000 g + 167 mL | | 2 × 10¹¹ CFU + |
| | | | | | 80 g |
| 7 | Duravel | MB1660** | 1000 | g | 5.5 × 10¹³ CFU |
| 8 | Duravel | MB1660 | 2000 | mL | 1.1 × 10¹⁴ CFU |
| 9 | Duravel + F9944-A | MB1660 + Fluindapyr | 1000 g + 167 mL | | 5.5 × 10¹³ CFU + |
| | | | | | 80 g |
| 10 | Duravel + F9944-A | MB1660 + Fluindapyr | 2000 g + 167 mL | | 1.1 × 10¹⁴ CFU + |
| | | | | | 80 g |
| 11 | ECO-Shot | D747*** | 1000 | g | 5 × 10¹³ CFU |
| 12 | ECO-Shot | D747 | 4000 | g | 2 × 10¹⁴ CFU |
| 13 | ECO-Shot + F9944-A | D747 + Fluindapyr | 1000 g + 167 mL | | 5 × 10¹³ CFU |
| 14 | ECO-Shot + F9944-A | D747 + Fluindapyr | 4000 g + 167 mL | | 2 × 10¹⁴ CFU + |
| | | | | | 80 g |
| 15 | Mancozeb 750 WG | — | 1500 | g | 1125 g |

CFU/mL:
*1.0 × 10⁸
**5.5 × 10¹⁰
***5.0 × 10¹⁰

F4028-1 (strain: FCC1256) used at 1000 and 2000 mL/ha showed synergistic effect with Fluindapyr at 167 mL/ha (Combination 5 and 6). In opposite, neither Duravel (strain: MB1660) at 1000 and 2000 g/ha nor ECO-Shot (strain: D747) at 1000 and 4000 g/ha did not show synergistic effect with Fluindapyr at 167 mL/ha

TABLE 8

| | | | | | % |
|---|---|---|---|---|---|
| | | Rates | | % | expected |
| Formu- | Products/ | mL or g | | observed | control |
| lations | combinations | product/ha | | control** | (Colby) |
| 1 | Untreated | — | | 0 a | — |
| | control | | | | |
| 2 | F9944-A | 167 | mL | 63 c | — |
| 3 | F4028-B | 1000 | mL | 0 a | — |
| 4 | F4028-B | 2000 | mL | 23 b | — |
| 5 | F4028-B + | 1000 mL + 167 mL | | 81 d | 61* |
| | F9944-A | | | | |
| 6 | F4028-B + | 2000 g + 167 mL | | 91 e | 71* |
| | F9944-A | | | | |
| 7 | Duravel | 1000 | g | 58 c | — |
| 8 | Duravel | 2000 | mL | 56 c | — |
| 9 | Duravel + | 1000 g + 167 mL | | 79 d | 84 |
| | F9944-A | | | | |
| 10 | Duravel + | 2000 g + 167 mL | | 77 d | 84 |
| | F9944-A | | | | |
| 11 | ECO-Shot | 1000 | g | 54 c | — |
| 12 | ECO-Shot | 4000 | g | 54 c | — |
| 13 | ECO-Shot + | 1000 g + 167 mL | | 65 c | 83 |
| | F9944-A | | | | |
| 14 | ECO-Shot + | 4000 g + 167 mL | | 81 d | 83 |
| | F9944-A | | | | |
| 15 | Mancozeb 750 | 1500 | g | 98 e | — |
| | WG | | | | |

*Synergistic effect
**Means followed by the same letter do not differ by Scott-Knott test at 5%

### Example 5—Synergy Between B. amyloliquefaciens FCC1256 and Fluindapyr Against Puccinia Triticina (Wheat Leaf Rust) was Evaluated in a Set of Two Consecutive Growth Chamber Experiments

One-week-old seedlings (variety Apache) were produced in growth chamber at 28° C., until their first leaf was fully developed. They were then labeled for product spray. Six replicates were prepared for each tested modality (1 replicate corresponding to 1 pot, itself containing approximately 30 seeds). Fungicide formulations presented in Table 9 were applied on wheat seedlings by spraying them at a volume of 240 L/ha inside laboratory spraying cabinet, using a one-nozzle boom positioned 40 cm from the plants. After spraying, seedlings were held at room temperature during 1 hour before being transferred inside a growth chamber, set up at following conditions: 20° C., RH 80% and a photoperiod of 16 h/8 h light/dark. After one day in the growth chamber, the plants were inoculated with a suspension of P. triticina spores at a concentration of 50,000 spores/mL. Seedling were then maintained in a dew chamber at 20° C. (24 hours dark) during 24 hours, before being transferred again in a growth chamber (20° C., RH 80% and a photoperiod of 16 h/8 h light/dark).

Disease severity was assessed on 5 leaves per pot 10 to 15 days after inoculation by estimating the relative leaf surface covered by pustules and associated chlorosis compared with total leaf surface.

The tested formulations are indicated in Table 9. Fluindapyr was evaluated inside a model EC formulation (F9944-C) (100 g fluindapyr/L) and used as a sublethal rate providing 50 to 60% of control. FCC1256 strain was tested inside a model formulation (F4028-D, not containing any adjuvants, and at concentration of 1.15×10¹⁰ CFU/mL), and used at three rates, 0.5 L/ha, 1 L/ha and 2 L/ha. Both fungicides were tested solo and in tank-mixture. Amistar (azoxystrobin 250 g/L SC) at 1 L/ha and F9944-A at rate of 1.5 L/ha were included as standards.

TABLE 9

| | | | Rate |
|---|---|---|---|
| Formu- | | Active | formulated |
| lation | Product | ingredient | product/ha |
| 1 | F9944-C | Fluindapyr | 0.1 L/ha |
| 2 | F4028-D | FCC1256 | 0.5 L/Ha |
| 3 | F4028-D + | Fluindapyr + | 0.5 L/ha + 0.1 L/ha |
| | F9944-C | FCC1256 | |
| 4 | F4028-D | FCC1256 | 1 L/ha |
| 5 | F4028-D + | Fluindapyr + | 1 L/ha+ 0.1 L/ha |
| | F9944-C | FCC1256 | |
| 6 | F4028-D | FCC1256 | 2 L/ha |
| 7 | F4028-D + | Fluindapyr + | 2 L/ha + 0.1 L/ha |
| | F9944-C | FCC1256 | |
| 8 | F9944-C | Fluindapyr | 1.5 L/ha |
| 9 | Amistar | Azoxystrobin | 1 L/ha |
| 10 | Untreated | — | — |

P. triticina control on wheat seedling (average of two tests) is presented in Table 10 below. Statistical analysis was done using ANOVA and Tukey test at 95% confidence.

TABLE 10

| | | Expected |
|---|---|---|
| PRODUCT | % control | (Colby) |
| F9944-C 0.1 L/ha | 56^{c} | |
| F4028-D 0.5 L/ha | 5^{ab} | |
| F4028-D 0.5 L/ha + | 73^{d} | 59 |
| F9944-C 0.1 L/ha | | |
| F4028-D 1 L/ha | 0^{a} | |
| F4028-D 1 L/ha + | 72^{cd} | 56 |
| F9944-C 0.1 L/ha | | |
| F4028-D 2 L/ha | 15^{b} | |
| F4028-D 2 L/ha + | 73^{d} | 63 |
| F9944-C 0.1 L/ha | | |
| F9944-C 1.5 L/ha | 100^{c} | |
| Amistar 1 L/ha | 100^{e} | |
| Untreated (64% severity) | 0^{a} | |

Different letters indicate significant differences between groups (p < 0.05).

The mixture of B. amyloliquefaciens FCC1256 and fluindapyr demonstrated a synergistic effect for the different FCC1256 rates tested.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The following represents embodiments of the invention

Embodiment 1. A method for controlling phytopathogenic fungi, the method comprising treating plants, plant propagation material, and/or associated soil with a pesticidal composition comprising an effective amount of:
(1) a Bacillus amyloliquefaciens fungicide component comprising a population of at least one strain of Bacillus amyloliquefaciens; and
(2) a second fungicide component comprising at least one fungicide selected from the group consisting of succinate dehydrogenase inhibitors,

wherein:

the population of the Bacillus amyloliquefaciens contained in the Bacillus amyloliquefaciens fungicide component and the second fungicide component are present in a ratio of from about 1×10⁷ CFU Bacillus amyloliquefaciens per gram succinate dehydrogenase inhibitor active ingredient to about 1×10¹⁵ CFU Bacillus amyloliquefaciens per gram succinate dehydrogenase inhibitor active ingredient; and

the phytopathogenic fungi is selected from the group consisting of Phakopsora pachyrhizi and Phakopsora meibomiae.

Embodiment 2. The method of Embodiment 1, wherein the at least one strain of Bacillus amyloliquefaciens is selected from the group consisting of FCC1256, AP-136, AP-188, AP-218, AP-219, AP-295, QST713, FZB24, FZB42, F727, MB1600, D747, RTI301, RTI472, and TJ100.
Embodiment 3. The method of Embodiment 2, wherein the at least one strain of Bacillus amyloliquefaciens is selected from the group consisting of FCC1256, AP-136, AAP-218, AP-219, AP-295, QST713, FZB24, FZB42, F727, MB1600, D747, RTI301, RTI472, and TJ100.
Embodiment 4. The method of Embodiment 3, wherein the at least one strain of Bacillus amyloliquefaciens is FCC1256.
Embodiment 5. The method of any one of Embodiments 1 to 4, wherein the second fungicide component is selected from the group consisting of benodanil, flutolanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypram, pyriflumetofen, boscalid, pyraziflumid, salts thereof, and combinations thereof.
Embodiment 6. The method of Embodiment 5, wherein the second fungicide component is selected from the group consisting of benzovindiflupyr, bixafen, fluindapyr, fluxapyroxad, furametpyr, inpyrfluxam, isopyrazam, penflufen, penthiopyrad, sedaxane, salts thereof, and combinations thereof.
Embodiment 7. The method of any one of Embodiments 1 to 4, wherein the second fungicide component is selected from a phenyl-benzamide, a phenyl-oxo-ethyl thiophene amide, a pyridinyl-ethyl benzamide, a furan carboxamide, an oxathiin carboxamide, a thiazole carboxamide, a pyrazole-4-carboxamide, an N-cyclopropyl-N-benzyl-pyrazole carboxamide, a pyridine carboxamide, and a pyrazine carboxamide, and salts thereof.
Embodiment 8. The method of Embodiment 7, wherein the second fungicide component is a pyrazole-4-carboxamide or a salt thereof.
Embodiment 9. The method of any one of Embodiments 1 to 8, wherein the second fungicide component is fluindapyr or a salt thereof.
Embodiment 10. The method of any one of Embodiments 1 to 9, wherein the population of the Bacillus amyloliquefaciens contained in the Bacillus amyloliquefaciens fungicide component and the second fungicide component are present in a ratio of from about 1×10⁷ CFU per g a.i. to about 1×10¹⁴ CFU per g a.i., from about 1×10⁷ CFU per g a.i. to about 1×10¹³ CFU per g a.i., from about 1×10⁷ CFU per g a.i. to about 1×10¹² CFU per g a.i., from about 5×10⁷ CFU per g a.i. to about 5×10¹¹ CFU per g a.i., from about 1×10⁸ CFU per g a.i. to about 1×10¹¹ CFU per g a.i., from about 5×10⁸ CFU per g a.i. to about 5×10¹⁰ CFU per g a.i., or from about 1×10⁹ CFU per g a.i. to about 1×10¹⁰ CFU per g a.i.
Embodiment 11. The method of any one of Embodiments 1 to 10, wherein the pesticidal composition is applied as a foliar treatment.
Embodiment 12. The method of any one of Embodiments 1 to 10, wherein the pesticidal composition is applied as a soil treatment.
Embodiment 13. The method of any one of Embodiments 1 to 10, wherein the pesticidal composition is applied as a seed treatment.
Embodiment 14. The method of any one of Embodiments 1 to 13, wherein the plant is of the genus Glycine.
Embodiment 15. The method of Embodiment 14, wherein the plant is soybean.
Embodiment 16. The method of any one of Embodiments 1 to 15 wherein the Bacillus amyloliquefaciens fungicide component and the second fungicide component are present in a synergistically effective amount.
Embodiment 17. A pesticidal composition comprising:
1) a Bacillus amyloliquefaciens fungicide component comprising a population of at least one strain of Bacillus amyloliquefaciens, and
2) a second fungicide component comprising at least one fungicide selected from the group consisting of succinate dehydrogenase inhibitors,

wherein the population of the Bacillus amyloliquefaciens contained in the Bacillus amyloliquefaciens fungicide component and the second fungicide component are present in a ratio of from about 1×10⁷ CFU Bacillus amyloliquefaciens per gram succinate dehydrogenase inhibitor active ingredient to about 1×10¹⁵ CFU Bacillus amyloliquefaciens per gram succinate dehydrogenase inhibitor active ingredient.

Embodiment 18. The pesticidal composition of Embodiment 17, wherein the at least one strain of Bacillus amyloliquefaciens is selected from the group consisting of FCC1256, AP-136, AP-188, AP-218, AP-219, AP-295, QST713, FZB24, FZB42, F727, MB1600, D747, RTI301, RTI472, and TJ100.
Embodiment 19. The pesticidal composition of Embodiment 18, wherein the at least one strain of Bacillus amyloliquefaciens is selected from the group consisting of FCC1256, AP-136, AAP-218, AP-219, AP-295, QST713, FZB24, FZB42, F727, MB1600, D747, RTI301, RTI472, and TJ100.
Embodiment 20. The pesticidal composition of Embodiment 19, wherein the at least one strain of Bacillus amyloliquefaciens is FCC1256.
Embodiment 21. The pesticidal composition of any one of Embodiments 17 to 20, wherein the second fungicide component is selected from the group consisting of benodanil, flutolanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypram, pyriflumetofen, boscalid, pyraziflumid, salts thereof, and combinations thereof.
Embodiment 22. The pesticidal composition of Embodiment 21, wherein the second fungicide component is selected from the group consisting of benzovindiflupyr, bixafen, fluindapyr, fluxapyroxad, furametpyr, inpyrfluxam, isopyrazam, penflufen, penthiopyrad, sedaxane, salts thereof, and combinations thereof.
Embodiment 23. The pesticidal composition of any one of Embodiments 17 to 20, wherein the second fungicide component is selected from a phenyl-benzamide, a phenyl-oxo-ethyl thiophene amide, a pyridinyl-ethyl benzamide, a furan carboxamide, an oxathiin carboxamide, a thiazole carboxamide, a pyrazole-4-carboxamide, an N-cyclopropyl-N-benzyl-pyrazole carboxamide, a pyridine carboxamide, and a pyrazine carboxamide, and salts thereof.
Embodiment 24. The pesticidal composition of Embodiment 23, wherein the second fungicide component is a pyrazole-4-carboxamide, or a salt thereof.

Embodiment 25. The pesticidal composition of any one of Embodiments 17 to 24, wherein the second fungicide component is fluindapyr or a salt thereof.

Embodiment 26. The pesticidal composition of any one of Embodiments 17 to 25, wherein the population of the Bacillus amyloliquefaciens contained in the Bacillus amyloliquefaciens fungicide component and the second fungicide component are present in a ratio of from about 1×10⁷ CFU per g a.i. to about 1×10¹⁴ CFU per g a.i., from about 1×10⁷ CFU per g a.i. to about 1×10¹³ CFU per g a.i., from about 1×10⁷ CFU per g a.i. to about 1×10¹² CFU per g a.i., from about 5×10⁷ CPU per g a.i. to about 5×10¹¹ CFU per g a.i., from about 1×10⁸ CFU per g a.i. to about 1×10¹¹ CPU per g a.i., from about 5×10⁸ CFU per g a.i. to about 5×10¹⁰ CPU per g a.i., or from about 1×10⁹ CFU per g a.i. to about 1×10¹⁰ CPU per g a.i.

Embodiment 27. The pesticidal composition of any one of Embodiments 17 to 26 further comprising at least one agriculturally acceptable adjuvant.
Embodiment 28. The pesticidal composition of any one of Embodiments 17 to 27, wherein the composition is in the form of a suspension, suspension concentrate, an oil dispersion, an emulsion, water-dispersible granules, or a foam.
Embodiment 29. The pesticidal composition of any one of Embodiments 17 to 28, wherein the composition is a solid, and wherein the population of Bacillus amyloliquefaciens is present at a concentration of from about 1×10⁶ CFU per gram to about 1×10¹² CFU per gram, from about 1×10⁷ CFU per gram to 1×10¹¹ CFU per gram or from about 1×10⁸ CFU per gram to about 1×10¹⁰ CFU per gram.
Embodiment 30. The pesticidal composition of any one of Embodiments 17 to 28, wherein the composition is a liquid, a suspension, a dispersion, or an emulsion, and wherein the population of Bacillus amyloliquefaciens is present at a concentration of from about 1×10⁶ CFU per mL to about 1×10¹² CFU per mL, from about 1×10⁷ CFU per mL to about 1×10¹¹ CFU per mL, or from about 1×10⁸ CFU per mL to about 1×10¹⁰ CFU per mL.
Embodiment 31. The pesticidal composition of Embodiments 30, wherein the composition is a premix.
Embodiment 32. The pesticidal composition of Embodiment 30, wherein the composition is a tank mix.
Embodiment 33. The pesticidal composition of any one of Embodiments 17 to 32, wherein the Bacillus amyloliquefaciens fungicide component and the second fungicide component are present in a synergistically effective amount.
Embodiment 34. The pesticidal composition of Embodiment 33, wherein, the Bacillus amyloliquefaciens fungicide component and the second fungicide component are present in a synergistically effective amount for the control of Phakopsora pachyrhizi or Phakopsora meibomiae.
Embodiment 35. A method for controlling phytopathogenic fungi, the method comprising treating plants, plant propagation material, and/or soil with an effective amount of the pesticidal composition of any one of Embodiments 17 to 34.
Embodiment 36. The method of Embodiment 35, wherein the phytopathogenic fungi is selected from Phakopsora pachyrhizi and Phakopsora meibomiae.
Embodiment 37. The method of Embodiment 35 or Embodiment 36, wherein the plant is of the genus Glycine.
Embodiment 38. The method of Embodiment 37, wherein the plant is soybean.
Embodiment 39. The method of any one of Embodiments 35 to 38, wherein the pesticidal composition is applied as a foliar treatment.
Embodiment 40. The method of any one of Embodiment 35 to 38, wherein the pesticidal composition is applied as a soil treatment.
Embodiment 41. The method of any one of Embodiment 35 to 38, wherein the pesticidal composition is applied as a seed treatment.

1. A method for controlling phytopathogenic fungi, the method comprising treating plants, plant propagation material, and/or associated soil with a pesticidal composition comprising an effective amount of:
(1) a Bacillus amyloliquefaciens fungicide component comprising a population of Bacillus amyloliquefaciens FCC1256; and
(2) a second fungicide component comprising at least one fungicide selected from fluindapyr and salts thereof.

2. The method of claim 1, wherein the pesticidal composition is applied as a foliar treatment.

3. The method of any one of claims 1 to 2, wherein the phytopathogenic fungi is selected from the group consisting of Phakopsora pachyrhizi and Phakopsora meibomiae.

4. The method of any one of claims 1 to 4, wherein the plant is soybean.

5. The method of any one of claims 1 to 2, wherein the phytopathogenic fungi is selected from Puccinia sp., e.g. Puccinia triticina.

6. The method of any one of claims 1 to 2 and 5, wherein the plant is a cereal.

7. The method of any one of claims 1 to 6, wherein the population of Bacillus amyloliquefaciens FCC1256 and fluindapyr are present in a ratio of from about 1×10⁷ CFU Bacillus amyloliquefaciens FCC1256 per gram fluindapyr to about 1×10¹⁵ CFU Bacillus amyloliquefaciens FCC 1256 per gram fluindapyr.

8. The method of any one of claims 1 to 7, wherein Bacillus amyloliquefaciens FCC1256 and fluindapyr are present in a synergistically effective amount.

9. A pesticidal composition comprising:
1) a Bacillus amyloliquefaciens fungicide component comprising a population of Bacillus amyloliquefaciens FCC1256, and
2) a second fungicide component comprising at least one fungicide selected from fluindapyr and salts thereof.

10. The pesticidal composition of claim 9, wherein the population of Bacillus amyloliquefaciens FCC1256 and fluindapyr are present in a ratio of from about 1×10⁷ CFU Bacillus amyloliquefaciens FCC1256 per gram fluindapyr to about 1×10¹⁵ CFU Bacillus amyloliquefaciens FCC1256 per gram fluindapyr.

11. The pesticidal composition of any one of claims 9 to 10 further comprising at least one agriculturally acceptable adjuvant.

12. The pesticidal composition of any one of claims 9 to 11, wherein the composition is in the form of a suspension, suspension concentrate, an oil dispersion, an emulsion, water-dispersible granules, or a foam.

13. The pesticidal composition of any one of claims 9 to 12, wherein the composition is a solid, and wherein the population of Bacillus amyloliquefaciens FCC1256 is present at a concentration of from about 1×10⁶ CFU per gram to about 1×10¹² CFU per gram, from about 1×10⁷ CFU per gram to 1×10¹¹ CFU per gram or from about 1×10⁸ CFU per gram to about 1×10¹⁰ CFU per gram.

14. The pesticidal composition of any one of claims 9 to 12, wherein the composition is a liquid, a suspension, a dispersion, or an emulsion, and wherein the population of Bacillus amyloliquefaciens FCC1256 is present at a concentration of from about 1×10⁶ CFU per mL to about 1×10¹² CFU per mL, from about 1×10⁷ CFU per mL to about 1×10¹¹ CFU per mL, or from about 1×10⁸ CFU per mL to about 1×10¹⁰ CFU per mL.
